(19) United States
(12) Patent Application Publication
(10) Pub. No.: US 2015/0345629 A1
(43) Pub. Date: Dec. 3, 2015

(54) GEAR, CAM STEPLESS TRANSMISSIONS AND VEHICLES THEREOF

(71) Applicant: Guangquan LIU, El Monte, CA (US)

(72) Inventor: Guangquan LIU, El Monte, CA (US)

(21) Appl. No.: 14/655,995

(22) PCT Filed: Dec. 26, 2013
(86) PCT No.: PCT/US13/77749

§ 371 Date: Jun. 26, 2015

Related U.S. Application Data
(60) Provisional application No. 61/746,618, filed on Dec. 28, 2012.

(51) Int. Cl. F16H 61/66; F16H 63/06

(52) U.S. Cl. CPC F16H 61/66; F16H 63/067

(57) ABSTRACT

The present invention provides stepless transmissions comprising a cam, one ore more gears, and one or more planetary gear systems responsible for power input and output, which enables stepless speed change under load and/or while stopping. The disclosure also encompasses vehicles, including but not limited to automobiles, aircrafts, helicopters, tanks, warships, submarines, tractors, and mine and construction vehicles, etc., that contain any of the stepless transmissions described herein.

### CROSS REFERENCE TO RELATED APPLICATIONS

This application claims the benefit under 35 U.S.C. §119(e) of U.S. Provisional Application No. 61/746,618, filed on Dec. 28, 2012, which is incorporated herein by reference in its entirety.

### FIELD OF THE INVENTION

The present invention relates to stepless (continuously variable) transmission (CVT) systems, which are capable of stepless speed change under load and/or while stopping with up to 95% power transmission efficiency, and transportation equipment, such as various vehicles containing a stepless transmission system.

### BACKGROUND OF THE INVENTION

Energy consumption, in particular oil consumption, is a persistent world problem. Due to its non-renewability and valuable properties, the crude oil is known as “black gold.” Global contentions for oil resources, such as economic wars, political wars and local wars fighting for territories, have never stopped. Accordingly, the U.S. federal government is proposing to set new automobile fuel-efficiency standards, requiring auto manufacturers to increase mileage on gas to 54.5 miles per gallon of gasoline by 2025. How to achieve high performance stepless speed change under load and/or while stopping with high power transmission efficiency while maintaining excellent fuel economy has become a prominent issue in the development of automotive transmissions.

Although mechanical CVT systems are in general more energy economic in comparison with automatic CVT systems, various issues exist, such as low capability to withstand overload and shock, low transfer power, and rough speed change transmission. The issues are more prominent especially when high-power machineries, such as automobiles, helicopters, tanks, warships, submarines, tractors, and mine and construction vehicles, etc., require stepless (continuously variable) transmission, in particular, stepless transmission under load.

Use automobile transmission systems to illustrate. Modern automobile transmissions widely use “stepwise planetary gear transmission” and “gear transmission” systems, which have characteristics such as reliable transmission, high transfer power, high efficiency, compact structure, and long life. In order to meet the needs of the automotive automation, modern automobiles use hydraulic mechanical continuously variable automatic transmission and use electronic technology in mechanical electronic automatic transmission. Whether hydraulic mechanical continuously variable automatic transmissions or electronic automatic mechanical continuously variable transmissions, or electronic automatic transmissions, they all incur power interruption in the process of gear shifting, thus resulting in loss of speed, power and speed differentiation. Automatic transmissions also have shortcomings such as high requirements of manufacturing technologies, complex structures, high costs, and difficult maintenance, etc. In particular, hydraulic mechanical continuously variable transmission and metal belt-type continuously variable transmissions also have vital shortcomings such as high power loss, i.e., high fuel consumption.

Automatic transmission generally costs more petroleum than mechanical transmission due to slip of its torque converter. Due to the adoption of the locking mechanism in high-speed region, the same economic efficiency could be achieved on automatic transmission as the mechanical transmission. But in low-speed region, the poor working performance of locking mechanism causes poor economic efficiency by about 10-15% on average. In other words, when running under the same conditions, a mechanical transmission automobile saves about 10-15% than automatic transmission automobile. See Automobile Engineering Manual, China Communications Press, May 2001, p. 134.

A “gear indicating system (gear indicator)” is suitable for mechanical shifting automobile. It is a system enabling driver to know the most economical running gear from indicating lamp on instrument on the basis of ensuring running performance. Shifting moment needs to be decided reasonably according to information such as automobile speed, engine rotating speed, air suction negative pressure, gear position of water temperature etc. Gear Indicating System is applied more frequently in the U.S., and its economic efficiency can be raised by 5-15%. In other words, a mechanical shifting automobile equipped with a “gear indicator” saves petroleum by 5-15% than mechanical shifting automobile without “gear indicator.” See Automobile Engineering Manual, China Communications Press, May 2001, p. 134.

However, when equipped with a “gear indicator,” a mechanical shifting automobile cannot realize automatic speed change, and manual speed change is guided via “gear indicator”. As a consequence, power is interrupted in speed change process, i.e., stepless speed change is unavailable, leading to power loss, speed loss, and speed difference loss. Meanwhile, due to the adoption of stepped transmission, optimal petroleum economy to match between engine rotating speed and automobile running speed is unavailable.

Moreover, gear transmissions are step-wise transmissions, which, when used in automobiles, contain three, four, five, or up to more than ten gears, thus causing inherent difficulties in automatic speed change. The more gears mean more complex automatic transmission, higher manufacturing cost and more difficult maintenance Gears cause power interruption when speed is changed. Therefore, dump trucks of higher than 100 tons cannot use gear transmissions, but can only use direct current (DC) motor for changing speed (i.e., electric wheel dump truck).

Therefore, fundamental technological breakthroughs on gear transmissions are needed in order to make automobile stepless transmissions and automatic stepless transmissions structurally simple, reliable, and having low manufacturing cost and convenient maintenance so that they can be widely used in micro, light and heavy-duty vehicles (including dump trucks of higher than 100 tons), as well as to improve automobile's power, reduce wear, and reduce fuel consumption.

### SUMMARY OF THE INVENTION

The present invention represents an afore-mentioned fundamental technological breakthrough in gear transmissions, by providing a solution to this world's challenging problem. Specifically, the present invention provides gear, cam stepless (continuously variable) transmission systems comprising one or more planetary gear mechanisms, a splined coupling mechanism, a gear drive mechanism, a cam mechanism, a ramp mechanism, and a rack mechanism.

In one aspect the present invention provides a stepless transmission, comprising:

a power input axle;

a power output axle;

a planetary gear mechanism; and

a speed changing assembly deposited on said power input axle through one or more gears;

wherein said power input axle and said power output axle are functionally connected by said planetary gear mechanism, and

wherein the transmission is capable of stepless speed change.

In one embodiment, the planetary gear mechanism comprises a first planetary gear system and a second planetary gear system that are coupled with each other; wherein said first planetary gear system is connected to said power input axle, and said second planetary gear system is deposited on said power output axle; and wherein power is transmitted from said power input axle through said planetary gear mechanism to said power output axle.

In another embodiment, the speed changing assembly comprises an axle, a cam, a gear rack piece, a ramp mechanism, one or more push rods, a mandrel, one or more gears, one or more springs, and an overrunning clutch system; wherein said cam is deposited on the power input axle; wherein said push rod, mandrel, and cam are kept connected through said springs, and said speed changing assembly can rotate around the power input axle; and wherein said ramp mechanism works together with the cam, the gear rack piece, the push rod, the mandrel, the springs, the one or more gears, and the overrunning clutch to achieve stepless speed change. The “gear, cam stepless transmission” of the present invention comprises a plurality of groups of load variable speed components, including a planetary gear mechanism 14, gears 11 and 13, cam 10, and members 1, 2, 3, 4, 5, 6, 7, 8, 9, and 12 as illustrated in the various Figures. While power is input through shaft I into the H member of the planetary gear mechanism; cam 10; gear 11, and the loaded speed changing components shunt-input the post-speed change power into the planetary gear mechanism B component, and upon synthesizing by the planetary gear mechanism, output the power through a member shaft III of planetary gear mechanism A.

The present invention also provides vehicles comprising a stepless transmission as described herein, including but not limited to automobiles, aircrafts, helicopters, tanks, warships, submarines, tractors, and mine and construction vehicles, or the like.

The present invention has changed the history that a mechanical continuously variable transmission (CVT) can only use friction- or impulse-type stepless speed change mechanisms. The invention has also solved issues related to the mechanical continuously variable transmission, such as low capability to withstand overload and shock, low transfer power, and rough speed change transmission, especially those related high-power machineries, such as automobiles, helicopters, tanks, warships, submarines, tractors, and mine and construction vehicles, etc., which require stepless (continuously variable) transmission, in particular, stepless transmission under load.

In comparison with mechanical shifting, power of “Gear/Cam Continuously Variable Transmission” of the present invention is not interrupted in speed change process, i.e., stepless speed change is available, not leading to power loss, speed loss or speed differential loss. In the meantime, optimal petroleum economy to match between engine rotating speed and automobile running speed can be achieved by controlling speed change via computer. As estimated according to the petroleum economization conditions, “Gear/Cam Continuously Variable Transmission” automobile can save petroleum by 10-15% than mechanical shifting automobile using a “gear indicator.”

The apparatus of the present invention not only possesses all the advantages of a gear transmission, but can also achieve stepless speed change. It can also achieve speed change during power transfer and achieve power transfer during speed change, i.e., achieving stepless speed change under load. There is no loss of speed, power or speed differentiation during speed change. It can also achieve stepless speed change while stopping (i.e., achieving stepless speed change while the engine stops rotating and the automobile not moving). The invention can achieve a speed change and gearing efficiency of up to 95%, and in the meantime, the speed change control mechanism is simple, safe and reliable, and capable of achieving stepless speed change under any environmental conditions under load or while the automobile is not moving.

### BRIEF DESCRIPTION OF THE DRAWINGS

FIG. 1 illustrates a simplified overall structure diagram of one embodiment of the gear, cam stepless transmission.

FIG. 2 illustrates a simplified overall structure diagram of another embodiment of the stepless transmission.

FIG. 3 illustrates two types of the planetary gear system: (a) NGW planetary gear system, and (b) WW planetary gear system.

FIG. 4 illustrates a simplified overall structure diagram of another embodiment of the gear, cam stepless transmission.

FIG. 5 illustrates polar coordinates of an Archimedes Spiral.

FIG. 6 illustrates rectangular coordinates of an Archimedes Spiral.

FIG. 7 illustrates characteristics of a ramp mechanism.

FIG. 8 illustrates helical gear engagement.

FIG. 9 illustrates the additional engagement of helical gears and the characteristics of its axial movement.

FIG. 10 illustrates the y=17x diagram.

FIG. 11 illustrates the y=18x diagram.

FIG. 12 illustrates the y=(18/17)x diagram.

FIG. 13 illustrates the y=18−17x diagram.

FIG. 14 illustrates the y=−17+18x diagram.

FIG. 15 illustrates the y=(18/17)x−1/17 diagram.

FIG. 16 illustrates the y=18−17x diagram.

FIG. 17 illustrates the y=18−(17+50/51)x diagram.

FIG. 18 illustrates the axial force of helical gears.

FIG. 19 illustrates the additional turn angle of helical gears.

FIG. 20 illustrates helical guide (a) and helical guide involute (b) diagrams.

FIG. 21 illustrates control of stepless speed change system.

FIG. 22 illustrates basic members of a planetary gear system.

FIG. 23 illustrates NGW planetary gear transmission.

FIG. 24 illustrates NW planetary gear transmission.

FIG. 25 illustrates WW planetary gear transmission.

FIG. 26 illustrates the working mechanism of a planetary gear system.

FIG. 27 illustrates an example of overrunning clutch.

FIG. 28 illustrates calculation of cam extending stroke curve and pressure angle.

FIG. 29 illustrates calculation of speed change transmission.

### DETAILED DESCRIPTION OF THE INVENTION

The present invention provides stepless (continuously variable) transmission systems, comprising a planetary gear mechanism, a splined coupling mechanism, a gear drive mechanism, a cam mechanism, a ramp mechanism, and a rack mechanism. In one embodiment, stepless transmission comprises a gear, a cam, a push rod, a mandrel, a ramp mechanism, and a planetary gear mechanism, the stepless transmission capable of stepless speed change. In one embodiment, the stepless transmission is characterized in that the cam pushes the push rod, and the push rod has four degrees of freedom to move radially up and down and axially left and right. In one embodiment, the stepless transmission comprises a pair of gears that causes the power-transmitting gear to do additional power transmission through the mandrel while transmitting the power. The stepless transmission of the present invention can achieve 95% transmission gearing efficiency, is structurally simple, safe and reliable, and is capable of stepless speed change under load and/or while stopping.

In one aspect the present invention provides a stepless transmission, comprising:

a power input axle;

a power output axle;

a planetary gear mechanism; and

a speed changing assembly deposited on said power input axle through one or more gears;

wherein said power input axle and said power output axle are functionally connected by said planetary gear mechanism, and

wherein the transmission is capable of stepless speed change.

In one embodiment of this aspect, the planetary gear mechanism comprises a first planetary gear system and a second planetary gear system that are coupled with each other; wherein said first planetary gear system is connected to said power input axle, and said second planetary gear system is deposited on said power output axle; and wherein power is transmitted from said power input axle through said planetary gear mechanism to said power output axle.

The planetary gear system can be of NGW, NW, or WW type, or combinations thereof.

In another embodiment of this aspect, the speed changing assembly comprises an axle, a cam, a gear rack piece, a ramp mechanism, one or more push rods, a mandrel, one or more gears, one or more springs, and an overrunning clutch system; wherein said cam is deposited on the power input axle; wherein said push rod, mandrel, and cam are kept connected through said springs, and said speed changing assembly can rotate around the power input axle; and wherein said ramp mechanism works together with the cam, the gear rack piece, the push rod, the mandrel, the springs, the one or more gears, and the overrunning clutch to achieve stepless speed change.

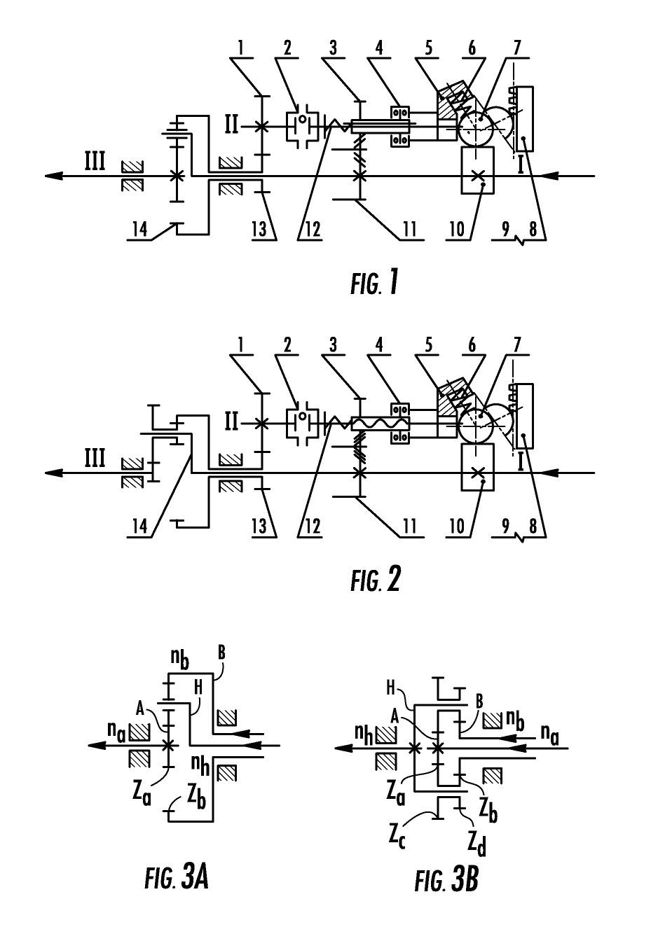

For illustration purpose, non-limiting examples of the stepless transmission system of the present invention are described in FIG. 1 and FIG. 2, etc.

In another embodiment of this aspect, the cam pushes a push rod, and the push rod has four degrees of freedom to move radially up and down and/or move axially left and right;

In another embodiment of this aspect, the mandrel is characterized that while transmitting power, a pair of gears cause a power-transmitting gear to make additional power transmission through the mandrel.

In another embodiment of this aspect, power is input through said power input axle into a first member of the first planetary gear system via said cam, one or more gears, and members of said speed changing assembly; the power input is shunt into a second member of the first planetary gear system; and after being synthesized and transmitted by the first planetary gear system, the power is output through the power output axle through the second planetary gear system.

In another embodiment of this aspect, the gear rack piece moves to change the bevel angle of the ramp mechanism, thus causing continuously variable speed change.

In another embodiment of this aspect, the cam pushes the push rod while moving up and down in the radial direction and moving left and right around the power input axle, and in the meantime the push rod moves axially left and right and pushes a power transmission gear for additional power rotation (i.e., the additional power transmission), wherein said power transmission gear is engaged with a second power transmission gear to cause other gears to change speed to input power into the first planetary gear mechanism via said overrunning clutch; and wherein after being synthesized and transmitted by the planetary gear mechanism, the driving gear member achieves power output through the axle (III) of the second planetary gear mechanism (A).

In another aspect the present invention provides a vehicle comprising a stepless transmission according to any of the embodiments described herein.

In one embodiment of this aspect, the vehicle is selected from automobiles, aircrafts, helicopters, tanks, warships, submarines, tractors, and mine and construction vehicles.

In a preferred embodiment of this aspect, the vehicle is selected from automobiles, tractors, and mine and construction vehicles.

In another aspect the present invention provides a stepless transmission comprising a power input axle, a power output axle, one or more planetary gear mechanisms, and a speed changing means comprising a cam and a ramp mechanism, wherein the transmission is capable of stepless speed change.

In one embodiment of this aspect, the speed changing means further comprises one or more push rods, a mandrel, a clutch, a gear rack piece, one or more gears, and one or more springs, wherein one or more push rods and mandrel are kept connected with each other through said one or more springs, and one of said one or more push rods.

In another embodiment of this aspect, the clutch is an overrunning clutch.

In another embodiment of this aspect, the cam pushes one of the push rods, and said one of the push rods has four degrees of freedom to move radially up and down and/or move axially left and right.

In another embodiment of this aspect, the mandrel is characterized that while transmitting power, a pair of gears causes a power-transmitting gear to make additional power transmission through the mandrel.

In another embodiment of this aspect, power is input through the power input axle (I) into a first member (H) of a first planetary gear mechanism (B) via cam 10, gear 11, and other members of said speed changing means (7, 5, 4, 3, 2, 1, and 13), see, e.g., FIG. 1 and FIG. 2; the power input is shunt into a second member of the first planetary gear mechanism (B); and after being synthesized by the first planetary gear mechanism (B), the power is output through a shaft member (III) of a second planetary gear mechanism (A). See FIG. 3(a) and FIG. 3(b).

In another embodiment of this aspect, the gear rack piece (9) moves to change the bevel angle of the ramp mechanism (8), and the cam (10) pushes a first push rod (7) while moving up and down in the radial direction and moving left and right around the shaft, and at the same time a second push rod (5) moves axially left and right and pushes a power transmission gear (3) for additional power rotation (i.e., the additional power transmission), wherein the power transmission gear (3) is engaged with another gear (11) to cause other gears (1 and 13) to change speed to input power into the first planetary gear mechanism (B) via an overrunning clutch (2), see FIG. 1 and FIG. 2; and after being synthesized and transmitted by the planetary gear mechanism (B), the driving gear member achieves power output through the shaft member (III) of the second planetary gear mechanism (A). See FIG. 3(a) and FIG. 3(b).

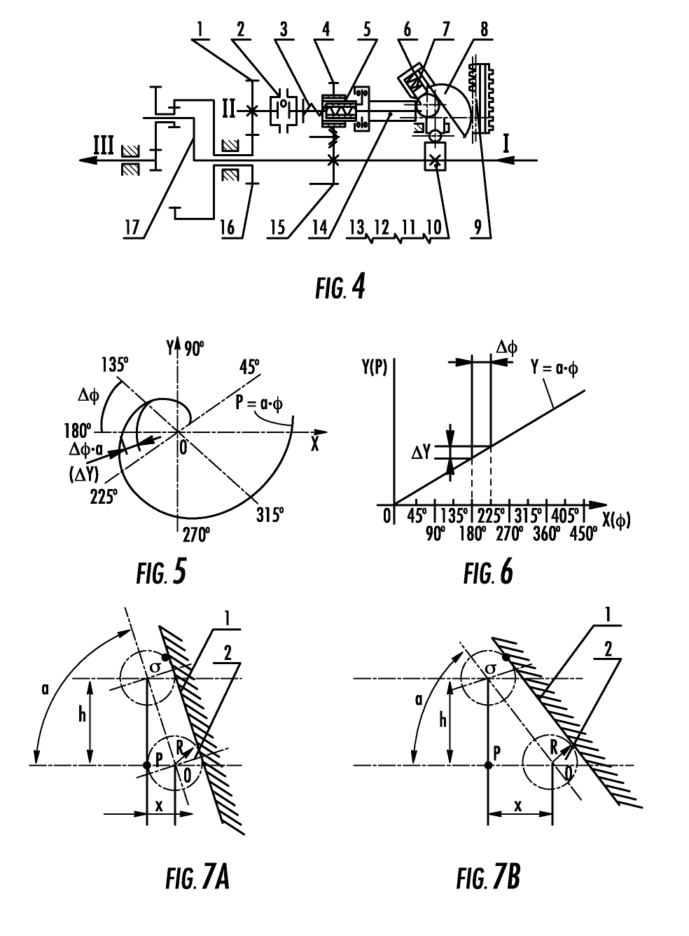

In another embodiment of this aspect, the present invention provides a stepless transmission substantially shown in FIG. 4, comprising planetary gear mechanism 17, gears 15 and 16, cam 10, and pieces 1, 2, 3, 4, 5, 6, 7, 8, 9, 11, 12, 13, and 14, wherein pieces 1, 2, 3, 4, 5, 6, 7, 8, 9, 10, 11, 12, 13, and 14 are loading stepless speed change mechanisms which are classified into four groups and uniformly distributed around the power input axle (I) as circle center and taking the axle center distance of axle II from axle I as radius. In a preferred embodiment, the interval among different groups is about 90°.

The planetary gear mechanism has a structure such as planetary gear mechanism (A), (B), and (H) as substantially shown in FIG. 3(a) and FIG. 3(b). While power is input through the power input axle I into the part H of the planetary gear mechanism, it passes through cam 10, gear 15, and the loading stepless speed change mechanisms; the post-speed change power is shunt into the part B of the first planetary gear system; and after being synthesized and transmitted by the first planetary gear system 17, the power is output through the power output axle III through the part A of the second planetary gear system.

In another embodiment of this aspect, the turn angle in the working travel of cam piece (10) is about 210°; three groups of loading speed change mechanisms drive gear piece (16) at the same time at most; at least two groups drive gear piece 16 at the same time; and the four groups drive alternatively.

In another embodiment of this aspect, the clutch piece (2) is characterized in that: when the rotating speed of gear piece 1 is higher than that of gear piece 4, the overrunning clutch piece (2) slides without transmitting power; and when the rotating speed of gear piece (1) is lower than that of gear piece (4), gear piece 4 is meshed via overrunning clutch piece 2 to transmit power to gear piece 1 and gear piece 16 for serving as power output of planetary gear n_{b} member.

In another embodiment of this aspect, when cam piece 10 returns, gear piece 4 does not perform any additional rotating movement; and when its speed is lower than gear piece 1, the overrunning clutch slides, thus cam piece 10 returns without outputting power.

In another embodiment of this aspect, the push rod piece 5 is an inner-outer spiral involute spline sleeve, and its axial force P=0 is balanced to reduce radial force of cam and push rod; the spring piece 3 is designed to drive the push rod piece 5 and mandrel piece 14 to be always contacted with push rod piece 13; and the play or gap is not allowed so as to realize parking stepless speed change.

In another embodiment of this aspect, the spring piece 7 is designed to be taken as force sealing mechanism of cam piece 10 and push rods 11, 12 and 13, thus cam piece 10 and push rods 11, 12 and 13 are always in working state.

In another embodiment of this aspect, one face of the gear rack piece 9 is provided with a rack which is meshed with the gear of ramp piece 8, and the other face is provided with end face screw thread; four claws are designed for three-claw chuck via chisel; the centering performance of three-claw chuck has a centration error of about 0.025 mm; angles α of four slope pieces 8 can be adjusted by rotating disk in three-claw chuck via angle gear, thus loading stepless speed change is realized; and meanwhile, gear piece 9 is provided with “gap clearing” device specific to slope piece 8 and screw threads on disk end faces of three claws, thus making loading stepless speed change accurate.

In another embodiment of this aspect, the gear piece 4 and piece 15 are each provided with 50 or 25 teeth, wherein when tooth number of gear piece 15 “becomes” “50.1 . . . 50, 25 . . . 53 . . . 53.03” due to additional turn angle under the action of gear piece 4, the requirement of different transmission ratios of Z₄/Z₁₅ is met.

In another aspect, the present invention provides a vehicle comprising a stepless transmission according to any one of embodiments described here, in particular those substantially described in FIG. 1, FIG. 2, FIG. 4, or the like.

The vehicles of the present invention include, but are not limited to, automobiles, aircrafts, helicopters, tanks, warships, submarines, tractors, and mine and construction vehicles, among which automobiles, tractors, and mine and construction vehicles are more preferred.

The present invention is applicable to stepless speed change and stepless speed change under load, such as automobiles, helicopters, tanks, warships, submarines, tractors, and mine and construction vehicles, or the like. If the automobile manual transmission is 15% more fuel efficient than the automatic CVT, the stepless transmission of the present invention is about 10% more fuel efficient than the manual transmission. When used in automobiles, the present invention is about 25% more fuel efficient than the hydraulic mechanical CVTs. Therefore, when used in automobiles, the present invention provides a safe, reliable, entirely new stepless transmission, which can save about 25% of refined oil, and at the same time, reduce about 25% of pollution emissions in comparison with the widely used hydraulic mechanical CVTs.

In another aspect, the present invention provides vehicles comprising a stepless transmission as described herein. The vehicles include, but are not limited to, automobiles, aircrafts, helicopters, tanks, warships, submarines, tractors, and mine and construction vehicles.

In the present disclosure, the term “stepless transmission” and “continuously variable transmission” are on occasions used interchangeably, and their meanings are well understood by a person of ordinary skill in the art.

The “planetary gear mechanism” as used in the present invention includes all types of planetary gear mechanisms (e.g. NGW, NW, WW, etc., gearing transmission types, or the like). The “planetary gear mechanism” also includes a series of two or more planetary gear mechanisms connected with each other in sequence. The three components of the “planetary gear mechanism” (e.g., see (a) and (b) of FIG. 3, where gear A, gear B, and pivot arm H are included) include one component for power input, one component for device fixing, and one component for power output; or two components for power input, and one component for power output.

The “gear drive mechanism” of the present invention includes all types of gear drive mechanisms, and also includes all types of gear tooth, such as involute profile, arc tooth profile, etc.

The “splined coupling mechanism” used in the present invention can be selected from splined coupling mechanisms, helical spline coupling mechanisms, as well as a spiro coupling mechanisms and rolling screw drive mechanisms.

The “cam mechanism” used in the present invention can be a planar cam mechanism or a spatial cam mechanism.

The “push rod” used in the cam mechanism as used in the present invention can be a spherical push rod, a cylindrical push rod, or a plate-shaped push rod, and can also be modular push rod (i.e., combination of spherical and cylindrical push rods, or a combination of spherical or cylindrical and plate shape push rods). The push rod of the present invention can be one having four degrees of moving freedom, i.e., capable of moving radially up and down while moving axially around (left and right), or having only two degrees of moving freedom.

The “rack mechanism” of the present invention includes a gear rack mechanism and a planar spiral rack mechanism.

For illustration purpose, in one embodiment, the working mechanism of the “gear, cam stepless transmission” of the present invention is briefly described below and illustrated in FIG. 2. When power is input through shaft I into member H of the planetary gear mechanism via cam 10, gear 11, and members 7, 5, 4, 3, 2, 1, and 13, it shunts the power input into member B of the planetary gear mechanism, after being synthesized by the planetary gear mechanism, the power is output through member III shaft of the planetary gear mechanism A. The moving rack 9 changes the bevel angle of the mechanism 8, and cam 10 pushes the pushing rod 7 while moving up and down in the radial direction and moving left and right around axial; and at the same time push rod 5 moves axially left and right; the push rod 5 pushing power transmission gear 3 for additional power rotation (i.e., the additional power transmission), wherein gear 3 is engaged with gear 11, causing gears 1 and 13 to change speed to input power into the planetary gear mechanism B via overrunning clutch 2; after being synthesized and speed change by the planetary gear mechanism, the driving gear member achieves power output through member III shaft of the planetary gear mechanism A.

In the “gears, cams stepless transmission” apparatus of the present invention, members 1, 2, 3, 4, 5, 6, 7, 8, 9, and 12 constitute a group of speed-changing components, the loaded speed-changing components being multi-group components.

Any terms used in the present disclosure, unless specifically defined otherwise, take ordinary meanings as understood by persons skilled in the art. The Figures and short-hand drawings of parts in the Figures, such as gears, planetary gear train, and overrunning clutches, etc. using standard symbols understood by those skilled in the art serve to illustrate the inventive concept of the present invention without limitation on the scope of the invention.

The following non-limiting examples set forth herein below illustrate certain aspects of the invention. The designs of functional prototypes of the present invention illustrated below may involve a number of mathematical formulas and calculations. As a person skilled in the art would appreciate, such mathematical formulas and calculations are provided solely as guidance on practice of the invention. None of the specific formulas or numbers is intended to be limiting on the scope of the invention. As a person skilled in the art would also understand, the numbers with long decimal points obtained from mathematic calculations illustrated below are provided merely for illustration purpose, but the numbers themselves are by no means limiting on the invention disclosed. Based on well-known and established mathematical principles, depending on situations and needs, such as types, sizes, and purposes of vehicles, specifications and dimensions of stepless transmissions, or parts thereof, may vary substantially, but they can be designed and manufactured to achieve the desired performance according to the present disclosure.

### Overall Design of Functional Prototype of “Gear and Cam Continuously Variable Transmission”

### I. Mathematical Model Basis

### 1. Δφ=Constant.

(1) Characteristics of Archimedes Spiral:

The polar coordinate of the Archimedes Spiral (see FIG. 5 and FIG. 6) is: ρ=a·φ. When the turn angle φ is on axis X, the rectangular coordinate is: ρ=Y=a·φ, and is a straight line (that is, Y=a·φ is a linear equation passing through the origin.)

The Archimedes Spiral has the characteristics that: a is a constant, and the value of Y varies with the value of φ.

When Δφ value of constant φ is equal, ΔY of the corresponding Y value is also equal (see FIG. 6).

When a·φ=constant, ΔY is also equal to constant, i.e., ΔY=constant.

(2) Characteristics of Ramp Mechanism:

As shown in FIG. 7(a): when cylinder piece 2 moves from 0 to 0′ and the distance is h, X=h/tan α.

When h is a constant value (i.e., h is a constant), Let: h=A and 1/tan α=Y, and the abovementioned formula is changed into: X=A·Y.

So, X=A·Y is a linear equation passing through the origin. Therefore, the characteristic of the ramp mechanism is that: when the value of h is unchanged, different X values can be obtained by changing the angle α value of the slope of piece 1 (see FIG. 7(b)).

(3) Helical Gear Engagement and the Characteristics of its Axial Movement:

See FIG. 8 and FIG. 9. Gear Z₂ moves axially from point A to point A₁ by value L₁. Let (Z₁/Z₂=1), if Z₁ is static, Z₂ rotates by arc length AA₁, i.e., the rotation arc length AA₁/(2Rπ/360)=angle φ₁.

Similarly, if gear Z₂ moves axially from point A to point A₂ by value L₂, Z₂ rotates by arc length AA₂, namely, the rotation arc length AA₂/(2Rπ/360)=angle φ₂.

According to the calculation above, the value of turn angle φ of Z₂ is only relevant to value L instead of the movement starting position of Z₂ no matter where point A is positioned, that is, L is a constant value while increment (or decrement) Δφ=constant.

When helical gear Z₁ is meshed with helical gear Z₂ for performing rotating transmission at speed V₁ and the transmission ratio is 1, if axial moving speed V of Z₂ is equal to the value of the moving distance L of Z₂ every time Z₁ rotates by a circle, so i=(360±φ)/360. If spiral angle α is consistent with the rotating direction of V₁, angle φ is a positive value (+φ); and if spiral angle α is opposite to the rotating direction of V₁, angle φ is a negative value (−φ).

### Example 1

Z₁=Z₂=50 teeth, and modulus m=2. Z₁ drives Z₂ to rotate, Z₁ rotates clockwise, the spiral direction of oblique teeth is a left-hand spiral direction, and β=36 degrees. The moving distance L of Z₂ along the axis of Z₁ is 20 mm every time Z₁ rotates by a circle.

Find: When the moving distance L of Z₂ along the axis of Z₁ is 20 mm every time Z₁ rotates by a circle while Z₁ drives Z₂ to rotate, find the transmission ratio i.

Solution:
1) find pitch circle diameters of Z₁ and Z₂: Φ=Z·m=50×2=100 mm
2) find spiral lead of helical gear: P=Φ·π/tan 36=432.403133
3) find angle φ_{f} in case of feeding of 20 mm/2π: φ_{f}=20/(P/360)=20/(432.403133/306)=16.651128°
4) find transmission ratio i: i=(360+16.651128)/360=1.046253134≈52.3/50=1.046=Z₁/Z₂

### Example 2

Given the involute spline of helical gear: Z=16, m=2.5, Φα=42 mm, pitch Φ=16×2.5=40 mm, spiral angle β=35 degrees, Z₁=Z₂=50 teeth, modulus m=2. Z₂ is connected with axle II via involute spline. Axial moving distance L of Z₂=18 mm (see FIG. 8)

Find: When the moving distance L of Z₂ along the axis of Z₁ is 18 mm every time Z₁ rotates by a circle while Z₁ drives Z₂ to rotate, find the transmission ratio i.

Solution:
1) find the lead of involute spline: P=40·π/tan 35=179.4663715.
2) find angle φ in case of feeding of 18 mm/2π: φ=18/(179.4883715/360)=36.35063972°
3) find transmission ratio i: i=(360+36.35063972)/360=1.1009739999≈55/50=1.1=Z₁/Z₂.
   2. y=A+B·x

(1) Linear Equation.

Calculate the characteristics of linear equation of planetary gear mechanism in which NGW and NW type meshed transmission mode is adopted according to general formula for calculating planetary gear speed ratio.

General formula for calculating speed ratio of NGW planetary gear mechanism:

let Z_{b}/Zₐ=u,
then,

nₐ=(1+u)·n_{b}−un_{b} (1)

General formula for calculating speed ratio of NW planetary gear mechanism:

let Z_{b}·Z_{c}/Z_{d}·Zₐ=u,
then,

nₐ=(1+u)·nₕ−un_{b} (2)

1) Planetary Gear Coupling
a) NGW type
   Given: Z_{b}=72, Zₐ=24, u=Z_{b}/Zₐ=72/24=3
      Calculation formula of speed ratio: nₐ=(1+3)·n_{b}−3n_{b}
   Let: nₕ=n_{b}=1r/min then: nₐ=4−3=1r/min
   Let: nₐ=nₕ=1r/min then: n_{b}=(4−1)/3=1r/min
   Let: nₐ=n_{b}=1r/min then: nₕ=(3+1)/4=1r/min
b) NW type
   Given: zₐ=21, Z_{d}=18, Z_{b}=102, 4=63, u=Z_{b}·Z_{c}/Zₐ·Z_{d}=17
      Calculation formula of speed ratio: nₐ=(1+17)·nₕ−17n_{b}
   Let: nₕ=n_{b}=1r/min then: nₐ=18−17=1r/min
   Let: nₐ=nₕ=1r/min then: n_{b}=(18−1)/17=1r/min
   Let: nₐ=n_{b}=1r/min then: nₕ=(17+1)/18=1r/min
c) According to the calculation above: when any two members in NGW and NW type planetary gear mechanisms are taken as inputs and have equal input rotating speeds, the planetary gear is integrated. Here, the planetary gear is a “coupling” of which the transmission efficiency is 100%.

2) Linear Equation of Planetary Gear

(a) Figures of one member is fixed, one member for inputting, and one member for outputting.

Formula: nₐ=18nₕ−17n_{b}

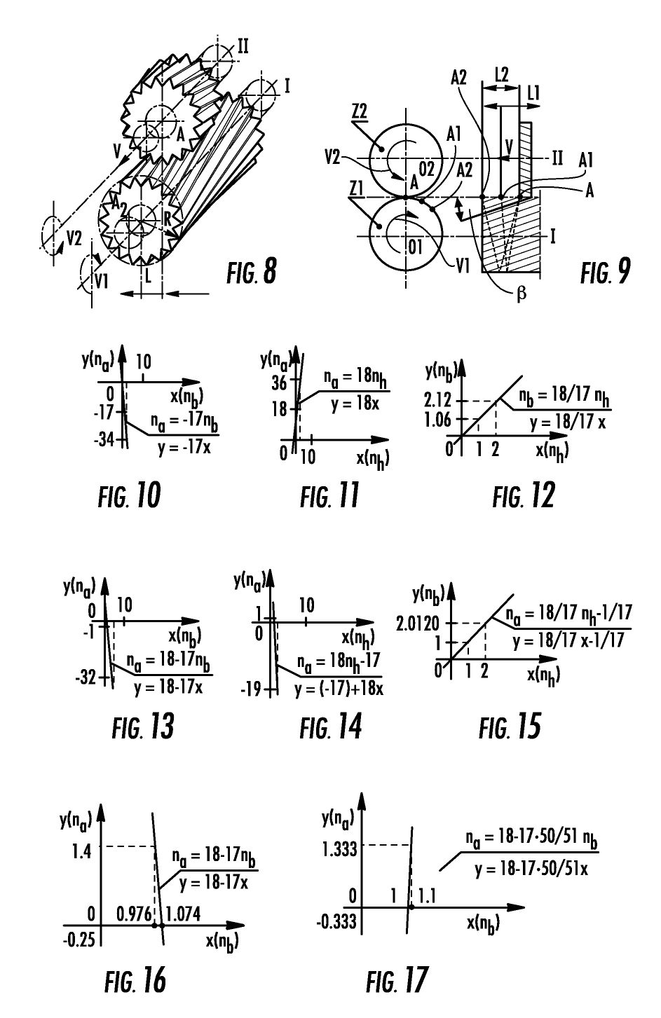

a) If: 18nₕ=0, then: nₐ=−17·n_{b}, so: y=−17x. See FIG. 10

b) If: −17n_{b}=0, then: nₐ=18nₕ, so: y=18x. See FIG. 11

c) If: nₐ=0, then: n_{b}=(18/17)nₕ, so: y=(18/17)x. See FIG. 12.

(b) Figures of linear equations in which two members are used for inputting and one member is used for outputting.

Formula: nₐ=18nₕ−17n_{b}

a) If nₕ=1, then: nₐ=18−17nₕ, so: y=18−17x. See FIG. 13.

b) If n_{b}=1, then: nₐ=18nₕ−17, so: y=−17+18x. See FIG. 14.

c) If nₐ=1, then: n_{b}=(18/17)nₕ−(1/17),
So: y=(18/17)x−(1/17). See FIG. 15.

(2) Adjustable Linear Equation and Figure
1)

Formula: nₐ=18nₕ−17n_{b} (3)
Let: nₕ=1r/min, then: nₐ=18−17n_{b}, so: y=18−17x
   If: y=nₐ=−0.25, 17n_{b}=18+0.25
      n_{b}=(18+0.25)/17=1.073529412
   If: y′=n′ₐ=1.4, 17n′_{b}=18-1.4
      n′_{b}=(18-1.4)/17=0.97647058
2) Figure of linear equation: (see FIG. 16)
3) Tooth matching calculation
   Optimal speed change range (namely, optimal turn angle difference)
      n_{b}=1.073529412≈54/50=1.08
      n′_{b}=0.976470588≈49/50=0.98
   Turn angle difference: φ=360/50 (54−49)=7.2×5=36°.
   Since 49/50 refers to negative angle running, form closure cannot be realized; therefore, slope of linear equation must be finely adjusted.
4) Calculation of finely-adjusted slope
   Let: nₐ=−0.25, nₕ=1, n_{b}=x(55/50)
      Then:

−0.25=18−17x(55/50) (4)
Let: n′ₐ=1.4, nₕ=1, n_{b}=x(55/50)
   Then:

1.4=18−17x(55/50) (5)
Formula (4) plus formula (5):
   1.4+(−0.25)=(18−17x)+[18−17x(55/50)]
      1.15=36 35.7x
   x=(36−1.15)/35.7=0.976190476
Let: x=50/51=0.980392156
So, formulae after fine adjustment are as follows:
   nₐ=18−17x(50/51)(55/50)=−0.33333333
   n′ₐ=18−17x(50/51)(50/50)=1.33333333333
Wherein, n_{b}=55/50; n′_{b}=50/50
So, 1/nₐ=−3; n′ₐ=0.75
5) Figure of linear equation after fine adjustment. (See FIG. 17)
   3. Mathematical Model: P=Pₐ±P_{b}; Φₐ+Φ_{c}

(1) P=Pₐ−P_{b}=0

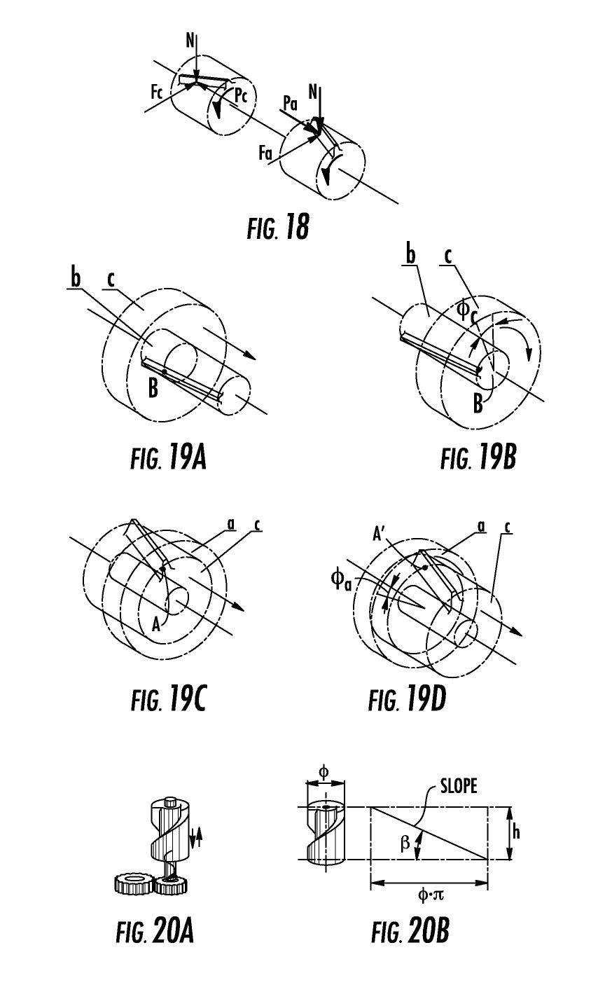

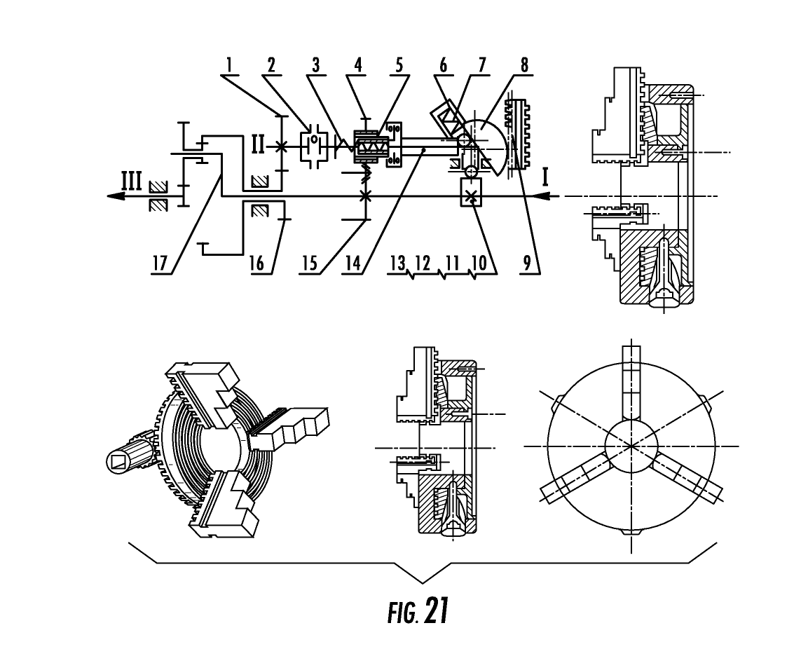

According to FIG. 18, when two helical gears (piece a and piece c) of which spiral angles are opposite rotate on the same axle (piece b) in the same direction, the axial force is calculated in the following way:
1) Let: driving force acting on helical gears (piece a and piece c) be N, and circumferential force acting on helical gears (piece a and piece c) be F,

Then:

F=N/R (6)
Wherein, R is the radius of each helical gear
2) Let: axial force acting on helical gears (piece a and piece c) as P,

Then:

P=tan β·F (7)

wherein, β refers to spiral angle of helical gear.
3) As shown in FIG. 18, the spiral angles of two helical gears (piece a and piece c) are opposite, i.e., helical gear a rotates in a right-hand way, and helical gear c rotates in a left-hand way, thus axial force P of the two helical gears is opposite. It is suggested to perform the following calculation after zeroing axial force acting on axle b.
   Given: Pₐ=tan βₐ·Fₐ=tan βₐ·N/Rₐ
      P_{c}=tan β_{c}·F_{c}=tan β_{c}·N/R_{c}
   Let: Pₐ be a positive value while P_{c} be a negative value
   So: P=Pₐ−P_{c}=0
   Then:

tan βₐ·N/R_{c}=tan β_{c}·N/Rₐ

tan β_{c}=tan βₐ·N·R_{c}/N·Rₐ.

tan β_{c}·Rₐ=tan βₐ·R_{c} (8)

(2) Φ=Φₐ+Φ_{c}

1) Additional Turn Angle Φ_{c}

According to FIG. 19(a) and FIG. 19(b), piece b and piece c construct a left-hand involute spline pair, namely, piece b is an outer spiral involute spline and piece c is an inner spiral involute spline. When piece b keeps static, and the inner spiral involute spline piece c moves axially from point B to point B′, the inner spiral involute spline piece rotates clockwise by additional turn angle (Φ_{c}). The additional turn angle is calculated as follows:
Given: piece b is a 30-degree circle root spiral involute outer spline. Z=15, m=2, β_{b}=18°
   D=z·m=15×2=30 mm R_{b}=15 mm
   Piece c is a 30-degree circle root spiral involute inner spline. Z=15, m=2, β=18°
   Dₐ=z·m=15×2=30 mm
   D′ₐ=m(z+1.8)=2(15+1.8)=33.6 mm
      Piece c moves from point B to point B′ by a distance: X=18 mm
Find: additional turn angle Φ_{c} of piece c
Solution: let: arc length BB′ be Y_{c}
   a) Y_{c}/X=tan β=tan 18°
      Y_{c}=tan β·x=tan 18° 0.18=5.848554532 mm
   b) additional turn angle Φ_{c}
   Φ_{c}=Y_{c}/(d·π/360)=5.848554532/(30·π/360)=22.33983273°

2) Additional Turn Angle Φₐ

According to FIG. 19(c) and FIG. 19(d), the outer circle right-hand spiral involute spline of piece c and the inner spiral involute of piece a construct a spiral spline pair. When piece a keeps static in the axial direction but can rotate, and piece c moves axially from point A to point A′, the inner spiral involute spline piece a rotates clockwise additionally. The additional turn angle (I)ₐ is calculated as follows:
Given: Piece c is a 30-degree circle root spiral involute outer spline. Z=25, m=2 β_{c}=28.4369994°, d=Z·m=25×2=50 mm, R_{c}=25 mm
Piece a is a 30-degree circle root spiral involute inner spline. Z=25, m=2 β_{c}=28.4369994°, D=Z·m=25×2=50 mm,
Dₐ=m(z+1.8)=2(25+1.8)=53.6 mm
Piece c moves from point A to point A′ by a distance: X=18 mm

Find: additional turn angle Φ_{c} of piece a

Solution: let: arc length AA′ be Yₐ
a) Y_{c}/X=tan β_{c}=28.4369994°
   Y_{c}=tan β_{c}·x=tan 28.4369994° 18=9.747590887 mm
b) additional turn angle Φₐ
   Φₙ=Yₐ/(d·π/360)=9.747590887/(50·π/360)=22.33983271°

3) Additional Turn Angle Φ

According to FIG. 19, inner hole of piece c and outer circle of piece b construct a left-hand spiral involute spline pair, and piece a on outer circle of piece c is a right-hand spiral involute spline pair. Piece c is actually an inner-outer spiral spline sleeve. Therefore, when piece b keeps static, piece a keeps static axially and can rotate circumferentially, and piece c moves axially by 18 mm, the additional turn angle of piece c relative to piece b is Φ_{c}, and the additional turn angle of piece a relative to piece c is Φₐ.

Then: the additional turn angle Φ of piece a relative to piece b is:
Φ=Φₐ+Φ_{c}=22.3398327+22.3398327=44.67966542°

According to the principle in FIG. 19, if piece b rotates at the same time, piece b rotates clockwise. Then: the additional turn angle Φ of piece a is a positive value. If piece b rotates anticlockwise, the additional turn angle Φ of piece a is a negative value.

Similarly, when the moving direction of piece c is consistent with that shown in the figure, the additional turn angle Φ of piece a is a positive value. If piece c moves opposite to that shown in the figure, the additional turn angle Φ of piece a is a negative value.

4) Calculation Formula of Additional Turn Angle Φ
Since:
   Yₐ/X=tan β_{c}, Yₐ=tan β_{c}·X
   Φₐ=Yₐ·360/d_{c}·π=tan β_{c}·X·360/d_{c}·π
Similarly: Φ_{c}=Y_{c}·360/d_{b}·π=tan β_{b}·X·360/d_{b}·π
And since: Φ=Φₐ+Φ_{c}
Then: Φ=tan β_{c}·X·360/d_{c}·π+tan β_{b}·X·360/d_{b}·π

∴Φ=(X·360/π)·(tan β_{c}/d_{c}+tan β_{b}/d_{b}) (9)

### II. Basis of Innovative Design:

### 1. Basis of Spiral Additional Turn Angle Mechanism:

FIG. 20(a) shows a spiral guide rail of slotting helical gear on gear shaping machine. During slotting of the helical gear, the shaft of gear shaper cutter is parallel to the shaft of gear, which is equivalent to a pair of parallel axle helical gears are meshed together. During gear cutting, additional spiral movement is performed apart from upward and downward cutting movement and generating motion, so that the generating surface of cutting edge movement is equivalent to the toothed surface of the helical gear. The additional spiral movement is obtained by means of spiral guide rail of machine tool.

Since the spiral angle of “spiral guide rail” for slotting the helical gear cannot be varied, several “spiral guide rails” with different spiral angles for processing helical gear are provided, and a gear shaper cutter for processing corresponding slotted helical gear is equipped.

“Speed change mechanism” is designed innovatively by using “reverse thinking” method. Let: the processed helical gear be taken as power input, and transmission gear shaper cutter move up and down during meshed transmission. Then: transmission of main axle of the gear shaping machine by a turn angle is added during meshed transmission, thus the aim of changing one rotating speed of the main axle of the gear shaping machine to another rotating speed is fulfilled.

2. Basis for Changing Spiral Guide Rail into Slope:

Under the restriction of the spiral guide rail, the spiral angle of the gear slotting mechanism cannot be varied. Therefore, the additional turn angle cannot be varied and can only be applied to special use.

According to FIG. 20(b), after the spiral guide rail expands, the “spiral guide rail” used on the gear shaping machine is substantially a ramp mechanism. Any spiral helical gear can be processed only by changing angle β in the ramp mechanism. Likewise, variation of the additional turn angle of the “main axle of gear shaping machine” can be realized only by changing angle β (refer to angle α in FIG. 7) in the ramp mechanism. Therefore, the aim of realizing loading stepless speed change and parking stepless speed change of “gear and cam continuously variable transmissions” can be fulfilled.

### 3. Basis of Mathematical Argument:

It can be learned from all modern mechanical variable transmission books or data, the calculation of the speed ratio of step gear variable speed or mechanical stepless variable speed transmission is not independent of the concept of i=Z₁/Z₂=R₂/R₁. A special pulse type stepless variable speed transmission (such as crank rocker pulse type stepless speed change) is adopted for adjusting the position of crank to realize speed change, namely, the concept of i=X/Y.

A general formula for calculating the speed ratio of planetary gear mechanism can be deduced by applying mathematical tools. Proof: The planetary gear mechanism adopting NW meshed transmission can be completely taken as a speed change amplifying mechanism when members H and b are taken as inputs while member a is taken as output.

That is,

nₐ=(1+u)·nₕ−un_{b} (2)
If: nₐ=18−17(50/51)·(52.333333/50), wherein 52.333333 does not refer to integer teeth.

Through mathematical operation reasoning, axial force of helical gear adopting parallel-axle single-stage meshed transmission can be fully balanced into zero.
P=P_{c}−P_{b}=0

Then:

tan β_{c}·Rₐ=tan βₐ·R_{c} (8)

As proven by mathematical operation reasoning, the additional turn angle formula of Φ=Φₐ+Φ_{c} has an amplifying function.

Then:

φ=(X·360/π)·(tan β_{c}/d_{c}+tan β_{b}/d_{b}) (9)

### III. Architecture Overview

### 1. Basic Power Transmission:

According to FIG. 4, power is input into gear piece 15 and cam piece 10 in a shunted way while being input into the planetary gear H member via axle I. When α of slope piece 8=90°, cam push rod pieces 10, 11, 12 and 13 do not drive plunger piece 14 to move axially (i.e plunger 14 does not move axially). Gear piece 15 drives gear piece 4, and gear piece 1 and gear piece 16 are driven via overrunning clutch piece 2.

In the Figure: gear piece 15/gear piece 4=50/50, gear piece 1/gear piece 16=50/51

Let: nₕ=1 r/min

Then: n_{b}=(50/51)·(50/50)

So: nₐ=18−17×(50/51)·(50/50)=1.3333333
1/nₐ=0.75

### 2. Power Variable Speed Transmission

When ramp mechanism piece 8 varies its angle α, plunger piece 14 is driven to move axially by value X while α=80° and the working travel moving distances h of cam push rod pieces 10, 11, 12 and 13=10.5 mm, then:

X=h/tan α=1.851433297 mm

Since top travel movement angle is equal to cam actuating travel movement angle Φ_{d}=210°, and four groups of loading stepless speed change mechanisms work together, top travel movement shall be calculated according to 2π. Then:

X_{f}=(X/210)·(360/50)=(1.851433297/210)·360=3.173885653 mm

According to FIG. 4, Structure Diagram of “Gear and Cam Continuously Variable Transmission”, piece 5 is an inner-outer spiral involute spline sleeve. Parameters of inner spiral involute spline are as follows: Z=15, m=2, β_{c}=18°, R_{b}=15 mm, d=30 mm, and parameters of outer spiral involute spline are as follows: Z=25, m=2, β_{c}=28.4369994°, R_{c}=25 mm, D=50 mm

The additional turn angle Φ=X_{f}·360/π·(tan β_{c}/R_{c}+tan β_{b}/R_{b}) (9)

So:
Φ=(3.173885653·360/π)·(tan 28.436999°/50+tan 18°/30)=7.878230591

So:
n_{b}=(50/51)(360+Φ)/360=(50/51)·(360+7.878230519)/360=1.001847033
nₐ=18−17·n_{b}=18−17·1.001847033=0.968600439
i=1/n_{b}=1/0.968600439=1.032417455
   The transmission ratio is equivalent to four-gear transmission ratio of automobile.

### 3. Continuous Variable Speed Transmission:

In FIG. 4, pieces 1, 2, 3, 4, 5, 6, 7, 8, 9, 10, 11, 12, 13, and 14 are loading stepless speed change mechanisms which are classified into four groups and are uniformly distributed around a circle taking the axle center of axle I as circle center and taking the axle center distance of axle II as radius. The interval among different groups is 90°.

Since the turn angle in the working travel of cam piece 10 is 210°, three groups of loading speed change mechanisms drive gear piece 16 at the same time at most, at least two groups drive gear piece 16 at the same time, and the four groups drive alternatively.

The overrunning clutch piece 2 is characterized in that: when the rotating speed of gear piece 1 is higher than that of gear piece 4, overrunning clutch piece 2 slides without transmitting power; and when the rotating speed of gear piece 1 is lower than that of gear piece 4, gear piece 4 is meshed via overrunning clutch piece 2 to transmit power to gear piece 1 and gear piece 16 for serving as power output of planetary gear n_{b} member.

Conversely, when cam piece 10 returns, gear piece 4 does not perform any additional rotating movement; and when its speed is lower than gear piece 1, the overrunning clutch slides, thus cam piece 10 returns without outputting power.

### 4. Functions of Other Mechanisms

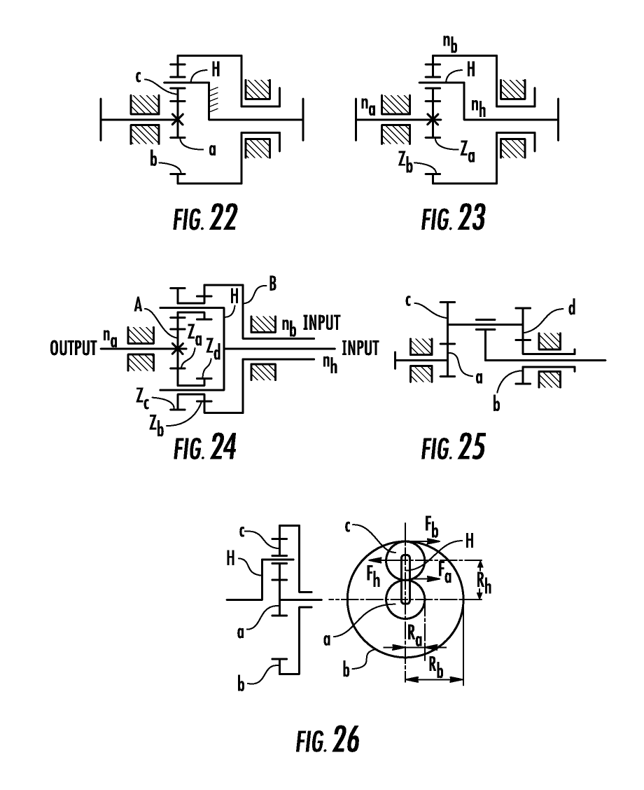

1) Since design piece 5 is an inner-outer spiral involute spline sleeve, and its axial force P=0 is balanced to reduce radial force of cam and push rod, spring piece 3 is designed to drive piece 5 and piece 14 to be always contacted with push rod piece 13; and play or gap is not allowed so as to realize parking stepless speed change.
2) Spring piece 7 is designed to be taken as force sealing mechanism of cam piece 10 and push rods 11, 12 and 13, thus cam piece 10 and push rods 11, 12 and 13 are always in working state.
3) One face of rack piece 9 is provided with a rack which is meshed with gear of slope piece 8, and the other face is provided with end face screw thread. As shown in FIG. 21, four claws are designed for three-claw chuck via chisel. (The centering performance of three-claw chuck is very high, and the centration error is 0.025 mm). Angles α of four slope pieces 8 can be adjusted accurately by rotating disk in three-claw chuck via angle gear, thus loading stepless speed change is realized. Meanwhile, gear piece 9 is provided with “gap clearing” device specific to slope piece 8 and screw threads on disk end faces of three claws, thus loading stepless speed change becomes accurate.
4) Gear piece 4 and piece 15 are provided with 50 or 25 teeth, i=1. When tooth number of gear piece 15 “becomes” “50.1 . . . 50, 25 . . . 53 . . . 53.03” due to additional turn angle under the action of gear piece 4, the requirement of different transmission ratios of Z₄/Z₁₅ is met.

### IV. Basic Parameters and Performance Indexes

### 1. Basic Parameters:

1) Overall dimensions: diameter×length=260 mm×660 mm.

2) Center height: h=130 mm.

3) Diameters of input and output shafts: Φ=30 mm.

### 2. Major Performance Indexes:

1) Loading stepless speed change

2) Parking stepless speed change

3) Transmission efficiency: about 95%

4) Oil saving: about 30%.

5) Reduction in emission pollution: about 30%.

### V. Safety and Regulations

### 1. Safety Performance

According to FIG. 4, when one group of loading stepless speed change mechanism of “gear and cam continuously variable transmission” is hit or damaged by bullet, “gear and cam continuously variable transmission” can run normally. Therefore, higher performance safety and reliability than other transmissions is realized.

### 2. According to Major Performance Indexes:

1) oil saving: about 30% and 2) reduction in emission pollution: about 30%, it is consistent with American related policy and regulation of energy saving and emission reduction.

### VI. Technological Difficulty and Solutions

### 1. Technological Difficulty:

1) Problems of vibration and noise caused by high-speed running of cam push rod.
2) Problem of wear of cam push rod, namely, problem of service life of “gear and cam continuously variable transmission”
3) Problem of speed change performance of loading stepless speed change mechanism.

### 2. Solutions:

1) Scheme for eliminating vibration and noise.
   a. Lower the linear speed of cam, design cam and input shaft integrally, and set radius of base circle: R_{b}=16 mm.
   b. Change directly-operated cam into offset cam, and improve radial force and inertia force of cam.
   c. Reduce working travel of push rod. Design movement angle of actuating travel into 210°, and travel: h=10.5 mm.
   d. Design push rod into combined push rod, and reduce weight and inertia force of push rod.
   e. Design radial force sealing spring piece 7 and spring seat piece 6 to be integrated with slope piece 8, and reduce thrust and inertia force.
   f. Design plunger piece 14 into flat and small-width push rod, and reduce the weight and inertia force of plunger.
   g. Design piece 5 inner-outer spiral involute spline, and eliminate axial force generated by left and right-hand spirals, namely, P=Pₐ+P_{c}=0. Reduce radial load of cam.
   h. Keep axial direction of gear piece 4 constant, and reduce radial force and inertia force of cam.
      The problems of vibration and noise caused in high-speed running of cam and push rod are solved via the eight schemes above.
2) Scheme for eliminating wear of cam push rod:
   a. Forced lubrication can be adopted, namely, oil pump is adopted for lubricating.
   b. Since wear curves of cam piece 10, combined push rod parts 11, 12 and 13, slope piece 8, plunger piece 14 and inner-outer spiral involute spline sleeve piece 5 are straight lines, the fitting length of inner-outer spiral involute spline sleeve piece 5 and gear piece 4 can be increased by 3 mm to realize preserved compensation length.
   c. Stress and wear of push rod piece 13 and cam piece 10 are most severe, so that wear-resistant high-quality steel must be adopted.
   d. Specific to the aim of reducing wear of cam, four groups of push rod parts 11 stressed in a way of being contacted with cam are designed at different axial positions of cam piece 10 respectively, and intervals among every group of axial positions are 2 mm.
   e. The concept of “preserving wear angle” is put forward during design of the working profile of cam. The so called “preserving wear angle” means setting Rₘₐₓ circular arc value and Rₘᵢₙ circular arc value as 10° respectively in return movement angle Φ′. Since cam and push rod only bear enclosing force and friction force of push rod during return movement, wear is very small. Wear of circular arc Rₘₐₓ and circular arc Rₘᵢₙ are also very small. Since working travel curve of cam is a straight line, circular arc is used for compensating after wear of cam to keep Archimedean curve of cam working travel constant and working actuating travel: h=10.5 mm constant.
3) Scheme for solving the problem of speed change performance of loading stepless speed change mechanism:

a. Gaps exist in spiral and gear and rack transmissions. Highly stable and accurate spiral and gear transmission or feeding amount is required, and fluctuation of feeding amount is not caused due to vibration of resistance. Therefore, “gap eliminating mechanism” must be designed.

One face of rack piece 9 is provided with a rack which is in meshed transmission with slope gear piece 8, and the other face is end face spiral which is meshed with “four-claw” chuck (see FIG. 21). Therefore, gaps exist on two faces of rack piece 9, which is extremely unbeneficial to stepless speed change.

Gear piece 9 is only taken as speed change mechanism instead of power transmission mechanism. Therefore, rack piece 9 can be designed into “bilateral automatic gap eliminating mechanism” so as to realize highly-accurate and stable speed change.

b. Since speed change is irrelevant to axial position of plunger piece 14, and is only relevant to slope of angle α of slope gear piece 8, slope gear piece 8, rack 9 and “four-claw” chuck are designed into components. After assembly of components, slope piece 8 is adjusted into: α=90°, and four groups of assemblies are processed at the same working position in a way that 8 α=90° so as to ensure that feeding angles α of the four groups are equal. Then, the components are placed into gearbox.

c. Four groups of spiral angles βa and βc of inner-outer spiral involute spline must be equal. Inner-outer spline broach can be adopted for processing during batch production so as to ensure that four groups of spiral angles βa and βc are equal. Inner spiral involute spline hole is processed by adopting high-accuracy spark processing on a single sample machine.

d. Pin roller type overrunning clutch having the characteristic of finely adjusting power transmission output is selected, thus errors occurring in speed change mechanism can be compensated while stable speed change output transmission is realized.

### Planetary Gear Transmission

### 1. Planetary Gear Train

In moving axis wheel transmission, one or more wheel axes rotate around another wheel or more than one wheel axes or a public axis line, which is called planetary gear train (or epicyclic gear train).

### <1> Planetary Gear Train and Classification

When the wheel in a planetary wheel train is a gear, from which the name of planetary wheel come.

(1) In planetary gear train transmission, when one member is unmovable, one member is taken as input, and one member is taken as output, it is called planetary gear transmission.

(2) In planetary gear train transmission, when two members are taken as inputs and one member is taken as output, it is called planetary gear combined transmission.

(3) In planetary gear train transmission, when one member is taken as input and two members are taken as outputs, it is called planetary gear differential transmission.

In general, planetary gear train transmission is collectively referred to as planetary gear transmission, and planetary gear combined transmission is collectively referred to as planetary gear differential transmission.

### <2> Planetary Gear Mechanism

1) Basic Members of Planetary Gear

As shown in FIG. 22, basic members of planetary gear consist of: a. sun wheel, b. inner gear, c. planet wheel and H planet carrier.

2) Planetary Gear Transmission Form

(i) Classification by Basic Members

For example, 2a-H, where a represents sun wheel member, H represents planet carrier member, and 2a-H represents two sun wheels and one planet carrier member.

(ii) Classification by Engagement Way

For example, NGW, where N represents inner engagement, W represents outer engagement, and G represents public planet wheel. NGW represents the presence of inner engagement and outer engagement transmission in planetary gear mechanism, and sharing of planet wheel.

For example, NW represents inner engagement and outer engagement transmission in planetary gear mechanism;

For example, WW represents outer engagement transmission in planetary gear mechanism.

### 2. Calculation of Speed Ratio of NGW Type Planetary Gear Mechanism:

<1> Fixed Axis Transmission

As shown in FIG. 23, when nₕ is fixed, i.e., nₕ=0, planetary gear transmission mechanism performs fixed axis transmission.
i.e.:

nₐ/n_{b}=−(Z_{b}/Zₐ) (1)

After phase shift:

nₐ=(−Z_{b}/Zₐ)n_{b} (2)
In formulae (1) and (2), the rotation directions of nₐ and n_{b} are opposite.

(2) Speed Ratio Calculation Formula:

When nₕ≠0, −nₕ which is equal to nₕ in opposite rotating direction is added to formula (1), i.e., “Absolute motion does not influence the relation of relative motion”.

So, the calculation formula of planetary gear transmission mechanism is as follows:

(nₐ−nₕ)/(nₕ−nₕ)=−(Zₕ/Zₐ) (3)

After phase shift:

$$\begin{matrix}{n}_{a} - {n}_{h} = ( - {Z}_{b} / {Z}_{a} ) ( {n}_{b} - {n}_{h} ) \\ = ( 1 / {Z}_{a} ) ( {Z}_{b} {n}_{h} - {z}_{b} {n}_{b} )\end{matrix}$$

After sorting:

Zₐnₐ−Zₐnₕ=Z_{b}nₕ−Z_{b}n_{b}

Zₐnₐ=(Z_{b}nₕ+Zₐnₕ)−Z_{b}n_{b}

nₐ=(Z_{b}/Zₐ+Zₐ/Zₐ)nₕ−(Z_{b}/Zₐ)n_{b}

∴nₐ=(1+Z_{b}/zₐ)nₕ−(Zₐ/Z_{b})n_{b} (4)

n_{b}=(1+Zₐ/Z_{b})nₕ−(Z_{b}/Zₐ)nₐ (5)

nₕ=1/(4+4)(Zₐnₐ+Z_{b}n_{b}) (6)

Let: Z_{b}/Zₐ=u

Then:

nₐ=(1+u)nₕ−un_{b} (7)

n_{b}=(1+1/u)nₕ−(nₐ/u) (8)

nₕ=(nₐ+un_{b})(1+u) (9)

### 3. Calculation Formula of Speed Ratio of NW Type Planetary Gear Transmission Mechanism:

See FIG. 24. Let: Z_{b}Z_{c}/Z_{d}Zₐ=−u
Then: (nₐ−nₕ)/(n_{b}−nₕ)=−u

According to the mechanism transmission diagram in FIG. 24: Zₐ and Z_{b} are in opposite rotating directions, so u is a negative value, i.e.: −u.

$$\begin{matrix}{n}_{a} - {n}_{h} = ( - u ) ( {n}_{b} - {n}_{h} ) \\ = {un}_{h} - {un}_{b}\end{matrix} \\ {n}_{a} = ( {un}_{h} - {un}_{b} ) + {n}_{h} \\ {n}_{a} ( {un}_{h} + {n}_{h} ) - {un}_{b} \\ ∴ {n}_{a} = ( 1 + u ) {n}_{h} - {un}_{b} \qquad ( 10 )$$

### 4. Calculation of Speed Ratio of WW Type Planetary Gear Transmission Mechanism:

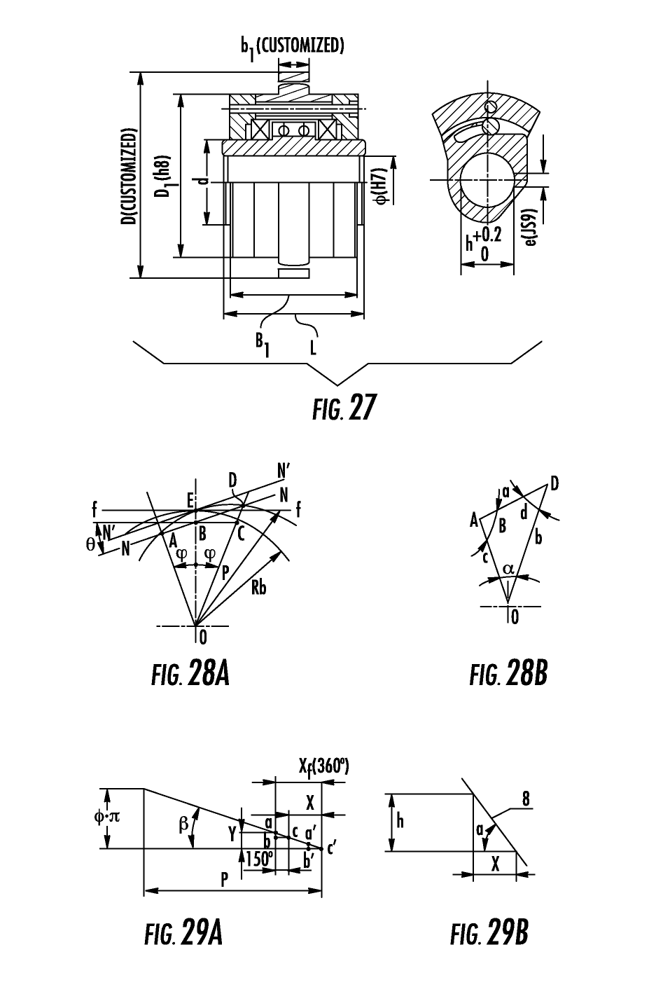

See FIG. 25. Let: Z_{b}Zₑ/Z_{d}Zₐ−u
Then: (nₐ−nₕ)/(n_{b}−nₕ)=u

According to the mechanism transmission diagram in FIG. 4: Zₐ and Z_{b} are in the same rotating direction, so u is a positive value.

nₐ−nₕ=u(n_{b}−nₕ)=(un_{b}−unₕ)

∴nₐ=un_{b}−(u−1)nₕ (11)

5. Deduction of Speed Ratio Calculation Formula of Planetary Gear Mechanism with the “Law of Conservation of Energy”

Acting force on planetary gear: (see FIG. 26). Torques acting on sun wheel a, inner gear b and planet carrier are Mₐ, M_{b} and Mₕ respectively:

Mₐ=Fₐ·Rₐ
M_{b}=F_{b}·R_{b}
Mₕ=Fₕ·Rₕ

Where: Rₐ and R_{b} refer to pitch radii of the sun wheel and the inner gear respectively. (See FIG. 26).

Rₕ takes the distance between the circle centers of Rₐ and R_{b} as the radius, i.e., the rotation radius of the planet carrier. (See FIG. 26).

Let: the gear ratio of the inner gear Z_{b} to the sun wheel Zₐ be u,
Then: u=Z_{b}/Zₐ=R_{b}/Rₐ
   ∴R_{b}=u·Rₐ
Since: Rₕ=(Rₐ+R_{b})/2
   ∴Rₕ=(Rₐ+uRₐ)/2=(1+u)·Rₐ/2

Where: Rₕ refers to the central distance between the planet wheel and the sun wheel. According to the force balance condition of the planet wheel 4 in the horizontal direction:
Fₐ=F_{b} and Fₕ=−2Fₐ

So, torques on the sun wheel a, the inner gear b and the planet carrier are as follows:

Mₐ=Fₐ·Rₐ

M_{b}=u·Fₐ·Rₐ

Mₕ=−(1+u)·Fₐ·Rₐ (12)

According to the “Law of Conservation of Energy”, the algebraic sum of input and output powers on the three elements is zero.

i.e.:

Mₐ·Wₐ+M_{b}·W_{b}+Mₕ·Wₕ=0 (13)

Where, Mₐ, M_{b} and Mₕ refer to the angular speeds of the sun wheel, the inner gear and the planet carrier respectively.

When Mₐ, M_{b} and Mₕ in formula (12) are substituted into formula (13):
Fₐ·Rₐ·Wₐ+u·Fₐ·Rₐ·W_{b}−(1+u)·Fₐ·Rₐ·Wₕ=0
Fₐ·Rₐ·[Wₐ+u·W_{b}−(1+u)·Wₕ]=0
   ∴Wₐ+u·W_{b}−(1+u)·Wₕ=0

If the angular speed is substituted by the rotating speed, then the formula above is changed to:

nₐ+n_{b}·u−(1+u)·nₕ=0

∴nₐ=(1+u)·nₕ−u·n_{b} (14)

In conclusion, formula (14) and formula (7) are completely the same, proving the correctness of the formulae from different laws of nature.

### Design Specification for Functional Prototype of “Gear/Cam Continuously Variable Transmission”

Since automobile type is not specified for the preparation of the design specification, data such as the interface type and size of an engine output end, suspension form, suspension position and size, the installing space, position and size of the “Gear/Cam Continuously Variable Transmission”, etc. are unavailable. It is impracticable to make a design by adopting the overall dimensions of an existing automobile transmission since the “Gear/Cam Continuously Variable Transmission” differs greatly from the existing automobile transmission in appearance. The major task of the design of functional prototype is: carrying out automobile transmission rack test by using the functional prototype of “Gear/Cam Continuously Variable Transmission”, and carrying out rack test with reference to China Automobile Industry Standards QC/T29063-92 and QC/T568-1999.

Detection: functional indexes of the transmission efficiency of the “Gear/Cam Continuously Variable Transmission”, the reliability and service life of load stepless speed change performance, the properties, vibration and noise during matched output with an engine, etc. Consequently, the aim of comprehensively evaluating the performance of the “Gear/Cam Continuously Variable Transmission” is fulfilled.

Design of major performances: major performances of the “Gear/Cam Continuously Variable Transmission” include load stepless speed change, parking stepless speed change and transmission efficiency. The optimal match efficiency of the “Gear/Cam Continuously Variable Transmission” and an engine as well as indexes such as vibration, noise, service life, etc. shall reach standard values of automobile transmission.

### 1. Power:

The maximum transmitted torque of the functional prototype of “Gear/Cam Continuously Variable Transmission” is: 375 N/m.

The maximum power of the functional prototype of “Gear/Cam Continuously Variable Transmission” is: 100 KW (i.e.: 135.96 horsepower)

### 2. Gear Modulus

Single stage: m=3, shunt transmission: m=2, combined transmission of three groups of planet wheels via planetary gear: M=1.5.

### 3. Speed Change Range:

Speed change range of a medium-sized automobile transmission is adopted, i.e.: i=−4−0.75

### 4. Transmission Ratio

Load stepless speed change transmission efficiency: η=95%

### 5. Lubrication:

Lubricating oil: gear oil and N150 gear oil.

Lubricating method: splash lubrication.

### 6. Vibration and Noise:

Vibration and noise shall reach specified standard values of automobile transmission.

### 7. Service Life:

Service life shall reach specified standard value of automobile transmission.

### 8. Simulation Test:

Test resulted efficiency of simulation optimal matching effect of “Gear/Cam Continuously Variable Transmission” and engine.

### Design Calculation for Functional Prototype of “Gear/Cam Continuously Variable Transmission”

### I. Overview:

“Transmission” applied to automobile is a device for changing the torque and rotation speed output of an automobile engine to meet the requirements of various different fraction forces and various different rotation speeds on automobile wheels during starting, acceleration and running of the automobile and under various road conditions.

Thus, it is particularly important to evaluate the contribution of a “transmission” to the power performance, fuel economy (i.e., transmission efficiency of the “transmission”), safety, operating reliability, and transmission stability of the automobile.

One object of the present invention is to design a functional prototype of “Gear/Cam Continuously Variable Transmission” to perform verification calculation on the load stepless speed change and parking stepless variable transmission efficiency of the “Gear/Cam Continuously Variable Transmission” as well as its ideal dynamic properties to match with the engine based on the structure of the prototype, with a main objective of calculating the performance and efficiency of the “prototype”. The performance characteristics of the “Gear/Cam Continuously Variable Transmission” are concluded from “rack” testing and adjustments.

In design work, three methods, including experience, analogy and theory, were adopted for designing. Experimental data and existing calculation formula were unavailable in the design process of the “Gear/Cam Continuously Variable Transmission”, thus the three methods above are applied in combination to the calculation and design of the functional prototype of “Gear/Cam Continuously Variable Transmission”.

### II. Structural Calculation:

1. Transmission Gear Modulus

Transmission gear modulus was selected according to the National Standard GB1357-78 of People's Republic of China.

### Normal Module of Automobile Transmission Gear

Automobile type

| | Mini and | Intermediate | Medium | Heavy duty |
|---|---|---|---|---|
| | ordinary cars | car | truck | vehicle |
| mn | 2.5-2.75 | 2.75-300 | 3.5-4.5 | 4.5-6 |

Set the gear transmission module of the transmission: M=3.

2. Design Calculation of Planetary Gear Mechanism:

Formula: nₐ=(1+u)nₕ−un_{b}. In order to design the planetary gear mechanism into a speed ratio amplifying mechanism, NW type planetary gear mechanism is selected (see FIG. 1).

Let: Zₐ=21, Z_{b}=102, Zₑ=63, Z_{d}=18, m=1.5, N_{w}=3.
H and B refer to inputs, and A refers to output.
   Let: nₕ=1 r/min, then u=17.

So,

nₐ=18nₕ−17n_{b}=18−17n_{b} (3)

3. Shut Transmission Calculation:
nb=(part 15/part 4) (part 1/part 16)=(50/50) (50/51)

so, nₐ=18−17n_{b}=18−17×(50/51)·(50/50)=1.333333

nₐ′=18−17n_{b}′=18−17×(50/51)·(54.75/50)=−0.25

Design: tooth numbers of gear part 15, part 4 and part 1 is 50, and tooth number of part 16 is 51. Module: m=2.

Four groups of gear parts 1 and parts 5 are designed to drive alternatively.

4. Calculation of Additional Rotation Angle

Internal and external spiral involute spline assemblies 5 (see FIG. 4).

Let: P=P_{c}=0,
Then:

tan β_{c}·R_{b}=tan β_{b}·R_{c} (8)

Let: β_{b}=18°, R_{b}=15 mm, R_{c}=25 mm. Find: β_{c}

Solution: tan β_{c}=tan β_{b}·R_{c}/R_{b}=tan 18°·25/15=0.541532827

β_{c}=28.4369994°

1) Internal spiral involute spline parameters are designed to be:

Z=15, m=2, β_{b}=18°, R_{b}=15 mm, d=30 mm

2) External spiral involute spline parameters are designed to be:

Z=25, M=2, β_{c}=28.4369994°, β_{c}=25 mm, D=50 mm

3) Additional rotation angle φ:

φ=(X_{f}·360/π)·(tan β_{c}/d_{c}+tan β_{b}/d_{b}) (9)

So: (I)=X_{f}·2.482203636

5. Calculation of Overrunning Clutch:

As an illustrative example, allowable torque and main dimensions of CY1B-series roller-type overrunning clutch are shown in FIG. 27 and Table 1.

TABLE 1
Torque and main dimensions of overrunning clutch

| Allowable | | | | | | | |
|---|---|---|---|---|---|---|---|
| Torque | D₁ | φ₁ | d₁ | e | h | L | B₁ |
| 250/N · m | 100 mm | 30 mm | 45 mm | 8 mm | 33.3 | 68 mm | 64 mm |
| | | | | | mm | | |

Bearing model refer to ultralight and superlight-series deep groove ball bearings in old standard, and the new standard is within parenthesis.

Part 2 is a CYIB-series roller-type overrunning clutch. Specification: 100B, allowable torque: 250/N·m, maximum diameter: D=100 m, maximum length: L=68 mm (See Table 1).

Two components 2 are adopted for outputting at the same time in the transmission, then the maximum output torque of the transmission is:
250×2×0.75=375/N·m

where, 0.75 refers to a safety factor.

6. Design Calculation of Cam:

(1) General Design Requirements of Cam Member 10 (See FIG. 4).

1) In order to reduce wear of cam, it is necessary to consider the maximum shaft diameter φmin of the input shaft while considering lowering the linear speed of the cam. Let: φmin=30 mm, the base radius of the cam is: R_{b}=16 mm.

2) In order to meet the working requirements of a linear equation mathematical model in which Δφ=constant and Δh=constant, the working profile curve and return curve of the cam are Archimedes spirals.

3) In order to decrease the weight ratio and increase the output power, “load stepless speed change mechanisms” in the “Gear/Cam Continuously Variable Transmission” are classified into four groups. (See FIG. 4, parts 1, 2, 3, 4, 5, 6, 7, 8, 9, 11, 12, 13 and 14 are classified into four groups). Among the four groups, at least two groups of the overrunning clutches perform power output at the same time.

4) Closed type of cam push rod parts 11, 12 and 13: (See FIG. 4) Shape sealing is performed on part 12 by using a transmission case while spring force sealing is adopted for part 7.

5) Specific to the aim of preventing the internal and external spiral involute spline assemblies 5 and carrier rod part 14 to move leftwards and rightwards on shaft II, spring part 3 is designed to keep part 5 and part 14 always in contact with push rod piece 13. (See FIG. 4)

6) Major design parameters of cam:

(a) Cam centering directly-operated mechanism is adopted.

(b) Cam extending stroke motion angle: φ=210°

(c) Cam reserved wear angle: φ=2×10=20°

(d) Cam return motion angle: φₕ=360−210−20−130°

(e) Extending motion angle stroke of push rod: Let: 2π stroke L=18 mm
Then: hₐ=(1/2π)·φ=(18/360)×210=10 5 mm

(f) Radius of push rod roller: R=9 mm

(2) Cam Extending Stroke Curve and Pressure Angle

1) Extending Stroke Curve
Let: Δt=hₐ/φ=10.5/210=0.05 mm, A=R_{b}=16 mm
Then: ρ=A+Δt·θ=16+0.05×θ
Where:
   θ - - - cam rotation angle
   Δt - - - extending stroke increment
   P - - - curvature radius

2) Extending Stroke Pressure Angle

Pressure angle is relevant to the base diameter of the cam after the determination of Δt. The smaller the base diameter, the larger the pressure angle is; and the larger the base diameter, the smaller the pressure angle is. Therefore, the maximum extending stroke pressure angle αₘₐₓ is calculated by using base R_{b} in the cam extending stroke (see FIG. 28)

As shown in FIG. 28, φ=1°, R_{b}=16 mm, Δ=0.05 mm/(°)

a={square root over (2(R²×0.0006091727+Δ²×1.99993927)}

sin ∠c=sin 2° (R_{b}−Δ)/a=sin 2° (16−0.05)/0567358581

φc=78.84879439°

Extending stroke pressure angle: αₜ=90°−∠c−1°=10.15120561°

(3) Return Curve Equation and Pressure Angle

1) Return Curve Equation

Let: Δh=hₐ/φₕ=10.5/130=0.00076923, A=R_{b}=16 mm

Then: cam return Archimedes spiral equation is:
ρ=A+Δh·θ=16+0.08076923×θ
Where:
   θ - - - return cam rotation angle
   Δh - - - return increment
   P - - - curvature radius

2) Return Pressure Angle

As shown in FIG. 2, φ=1°, Δh=0.08076923 mm/n(°), Rₕ=16 mm

$$\begin{matrix}a = \sqrt{2 ( {R}_{b}^{2} \times 0.0006091727 + Δ {h}^{2} \times 1.99993927} \\ = \sqrt{2 ( 0.155948032 + 0.01304694 )} \\ = 0.581369025\end{matrix}$$

sin ∠c=sin 2° (R_{b}−Δh)/a=sin 2° (16−0.08076923)/0.581369025

∠c=72.86808348°

Return pressure angle: αₕ=90°−∠c−1°=16.13191652°

(4) Issues Related with Cam Design and Calculation
1) Cam extending stroke curve and preserved wear angle adopted by the “Gear/Cam Continuously Variable Transmission” cannot be varied.
2) Extending stroke pressure angle: αₜ<30°, design is reasonable.
3) Return pressure angle: αₕ<30°, design is reasonable.
4) Since Δt and Δh of the cam are small, and the extending stroke curve must be an Archimedes spiral, it is easy to resolve the practical profile curve of the cam by adopting a calculation method and a construction method. In order to inspect the radial stress status of the cam intuitively, a directly-driven cam push rod is adopted in the functional prototype of “Gear/Cam Continuously Variable Transmission”.
5) In order to reduce the radial force of the cam and the push rod, the push rod can be directly driven away from the center of the cam. Since it is necessary to ensure that the extending stroke is an Archimedes spiral, it is difficult to resolve the practical profile curve of the cam.

7. Calculation of Variable Transmission:

(1) Gears of the Transmission of an Embodiment of “Mini-Cars”

TABLE 2
Transmission ratios of transmission in mini-car

Gear

| | 1 | 2 | 3 | 4 | 5 | R |
|---|---|---|---|---|---|---|
| i | 3.625 | 1.927 | 1.423 | 1 | 0.795 | 3.466 |
| nₐ = 1/i | 0.276 | 0.514 | 0.703 | 1 | 1.258 | −0.289 |

Transmission ratio i of rear axle: 5.125

According to the transmission ratio: i=engine rotation speed/transmission output rotation speed. The output rotation speed of the “Gear/Cam Continuously Variable Transmission” is: na

Then: i=engine rotation speed/na; Let: the engine rotation speed=1 r/min

So, i=1/nₐ or nₐ=1/i.

(2) Find: transmission ratio Xz

Formula: nₐ=18−17(50/51)X_{z}

Then: X, =(18−nₐ)×51/17×50

Gear 1, X_{z}=(18−0.276)×51/17×50=1.06344

Transmission ratios Xz of other gears are shown in table 3

TABLE 3
Transmission ratios Xz

| | Gear | | | | | |
|---|---|---|---|---|---|---|
| | 1 | 2 | 3 | 4 | 5 | R |
| X_{z} | 1.06344 | 1.04916 | 1.03782 | 1.02 | 1.00452 | 1.09734 |

(3) Find: Additional Rotation Angle φ_{f}.

Basic rotation speed: gear part 15/gear part 4=1

So, φ_{f}=(X_{z}−1)×360

Gear 1, φ_{f}=(1.06344−1)×360=22.8384°

Additional rotation angles φ_{f} of other gears are shown in table 4.

TABLE 4
Additional rotation angles φ_{f}

| | Gear | | | | | |
|---|---|---|---|---|---|---|
| | 1 | 2 | 3 | 4 | 5 | R |
| φ_{f} | 22.8384 | 17.6976 | 13.6152 | 7.2 | 1.6272 | 35.0424 |

(4) Find: 2π Feed X_{f}

φ_{f}=(X_{f}·360/π)·(tan β_{c}/d_{c}+tan β_{b}/d_{b})=X_{f}×114.591559×0.021661313=X_{f}×2.482203636

So, X_{f}=φ_{f}/2.482203636

Gear 1, X_{f}=22.8384/2.482203636=9.200856718

For 2π feed X_{f} of other gears, see table 5. (Refer to calculation FIG. 29)

TABLE 5
2π feed X_{f}

| | Gear | | | | | |
|---|---|---|---|---|---|---|
| | 1 | 2 | 3 | 4 | 5 | R |
| X_{f} | 9.20086 | 7.12979 | 5.48513 | 2.90065 | 0.65555 | 14.11746 |

(5) Find: 210° Feed X

X=X_{f} 210/360=X_{f}×0.58333333

Gear 1, X=9.20086×0.5833333=5.367166419

210° feed X of other gears are shown in table 6. (Refer to calculation FIG. 29)

TABLE 6
210° feed X

| | Gear | | | | | |
|---|---|---|---|---|---|---|
| | 1 | 2 | 3 | 4 | 5 | R |
| X | 5.36717 | 4.15906 | 3.14466 | 1.69204 | 0.382402 | 8.2351825 |

(6) Find: Angle α of Slope Part 8

Formula: tan α=h/X, where: h=10.5 mm.

Then: in gear 1, tan α=10.5/5.367166419=1.956339562
∠α=62.92575762°

Angle α of other slope gear part 8 is shown in table 7. (Refer to calculation FIG. 29)

TABLE 7
Angle α of other slope gear part 8

| | Gear | | | | | |
|---|---|---|---|---|---|---|
| | 1 | 2 | 3 | 4 | 5 | R |
| ∠α | 62.9258 | 68.3915 | 73.3275 | 80.8456 | 87.9143 | 51.8928 |

(7) Summary of Calculation of Gear Variable Transmission:

TABLE 8
Gear variable transmission calculated values of the
“Gear/Cam Continuously Variable Transmission”

| | Gear | | | | | |
|---|---|---|---|---|---|---|
| Item | 1 | 2 | 3 | 4 | 5 | R |
| i | 3.625 | 1.947 | 1.423 | 1 | 0.795 | 3.466 |
| nₐ | 0.276 | 0.514 | 0.703 | 1 | 1.258 | −0.289 |
| X_{z} | 1.06344 | 1.04916 | 1.03782 | 1.02 | 1.00452 | 1.09734 |
| φ_{f} | 22.8384 | 17.6976 | 13.6152 | 7.2 | 1.6272 | 35.0424 |
| X_{f} | 9.20086 | 7.12979 | 5.48514 | 2.9007 | 0.6556 | 14.1175 |
| X | 5.36717 | 4.15905 | 3.14466 | 1.69204 | 0.3824 | 8.2352 |
| α | 62.9258 | 68.3915 | 73.3275 | 80.8456 | 87.9143 | 51.8928 |

### III. Calculation Formula of Transmission Ratio of “Gear/Cam Continuously Variable Transmission”

Let: nₐ=0, 0.25, 0.5, 0.75, 1, 1.25. Find X_{z}, φ_{f}, X_{f}, X and α listed in table 9 respectively.

TABLE 9
Table of calculated values of transmission ratios

| | nₐ | | | | | |
|---|---|---|---|---|---|---|
| | 0 | 0.25 | 0.5 | 0.75 | 1 | 1.25 |
| X_{z} | 1.08 | 1.065 | 1.05 | 1.035 | 1.02 | 1.005 |
| φ_{f} | 28.8 | 23.4 | 18 | 12.6 | 7.2 | 1.8 |
| X_{f} | 11.6026 | 9.427 | 7.252 | 5.076 | 2.901 | 0.7252 |
| X | 6.76817959 | 5.499145918 | 4.230 | 2.961 | 1.692 | 0.423 |
| A | 57.1946 | 62.3577 | 68.057 | 74.25115 | 80.8456 | 87.693 |

Let: Xₐ=K·nₐ+X, when nₐ=0, X=6.76817959

Then, Xₐ=X=6.76817959

Let: n′ₐ=0.25, Xₐ=5.499145918. The interval of nₐ and n′ₐ is: 0.25.

Then: 5.4499145918=0.25·K+6.76817959
K=(5.499145918−6.76817959)/0.25

So: X=6.76817959−5.076134688·nₐ
nₐ=(6.76817959−X)/5.076134688=1.333333−X/5.076134688

X=h/tan α, h=10.5 mm, X=10.5/tan α
So, the formula for calculating the variable transmission ratio of the functional prototype of the “Gear/Cam Continuously Variable Transmission” is as follows:

$$\begin{matrix}{n}_{a} = 1.333333 - ( 10.5 / tan α ) / 5.076134688 \\ = 1.333333 - 2.0685 / tan α\end{matrix} \qquad ( A )$$

### IV. Calculation of Transmission Efficiency:

1. Calculation of Shut Transmission Efficiency

In combined transmission of planetary gear used in the “Gear/Cam Continuously Variable Transmission”: (See FIG. 4) nb performs variable transmission input during constant-speed transmission input of nH. na performs power transmission output after combination with a planetary gear mechanism.

So, power transmitted by nb is a half of the total power.

P=Pₐ−Pₕ=0 (see II, 4 Calculation of additional rotation angles). Moreover, in basic transmission: gear part 15/gear part 4=1, slope part 8, angle α is more than 45° (α>45°). Axial force of the push rod part 13 is less than radial force. (See tables 8 and 9 as well as FIG. 4)
Then: shut transmission efficiency is:

η_{f}=1−(X₂+0.04−1)/2 (B)
Where,
   ηf - - - shut transmission efficiency
   Xz - - - variable-speed transmission ratio
   0.04 - - - engagement transmission loss of two-stage gear
Let: gear 1, Xz - - - 1.06344
   η_{f}=1−(X_{z}+0.04−1)/2=1−(1.06344+0.04−1)/2=0.94828
Shut transmission efficiency values of other gears are shown in table 10.

TABLE 10
Shut transmission efficiency values

Gear

| | 1 | 2 | 3 | 4 | 5 | R |
|---|---|---|---|---|---|---|
| η_{f} | 0.948 | 0.955 | 0.961 | 0.97 | 0.9777 | 0.931 |

2. Calculation of Combined Transmission Efficiency of Planetary Gear:

Calculation of efficiency input by H and b and output by a (See FIG. 4)

Formula: ηₐ=1−|(nₐ−nₕ)/nₐ|Ψ (C)
Where: Ψ=0.025

Let: nₕ=600 r/min, nₐ=6000×0.276=1656 r/min
ηₐ=1−|(1656−6000)/1656|0.025=0.9344

η value of combined planetary gear input of other gears is shown in table 11.

TABLE 11
Engagement efficiency of planetary gear

Gear

| | 1 | 2 | 3 | 4 | 5 | R |
|---|---|---|---|---|---|---|
| ηₐ | 0.934 | 0.976 | 0.989 | 1 | 0.994 | 0.888 |

3. Transmission Efficiency of “Gear/Cam Continuously Variable Transmission”

Formula: η₁=η_{f}·ηₐ (η value of each gear is shown in table 12)

TABLE 12
Transmission efficiency of “Gear/Cam Continuously
Variable Transmission”

Gear

| | 1 | 3 | 3 | 4 | 5 | R |
|---|---|---|---|---|---|---|
| η | 0.886 | 0.932 | 0.95 | 0.97 | 0.972 | 0.827 |

### V. Verification Calculation of Related Structure

1. Bearing Selection and Speed Calculation

Member with the maximum rotation speed in the “Gear/Cam Continuously Variable Transmission” is: gear part 4 (See FIG. 4). Gear part 4 is designed with a cantilever structure, and the diameter of the cantilever shaft is: φ=45 mm. Model 7009C “angular contact ball bearing” with the dimensions d×D×B=45×75×16 is selected.

Let: the input rotation speed nₕ=7000 r/min

(1) Gear R, X_{z}=1.09734=X_{zmax}
Then: nₘᵢₙ=nₕ·X_{zmax}=7000×1.09734=7681.38 r/min

(2) Gear 3, X_{z}=1.03782
Then: n=7000×1.03782=7264 r/min

The limit rotation speed of 7009C angular contact ball bearing lubricated with “grease”: n_{g}=7500r/min, and the limit rotation speed of 7009C angular contact ball bearing lubricated with “oil”: n_{g}=10000r/min.

Since: nₘₐₓ=7681.38<10000 r/min, n=7264<7500 r/min

Bearing is selected, and design is reasonable.

2 Planetary gear assembly condition and transmission ratio check:
(1) Relevant allowable value of NW meshed planetary gear mechanism.
   1) Transmission ratio range: b is fixed, a is a driving part, and H is a driven part. i=1.55-21.
   2) Single-stage transmission ratio of gear: i=8.
   3) Assembly condition:
      (Zₐ+4)/nw=integer teeth
         Where, nw - - - number of planet wheel groups.
(2) Check:
   1) Transmission ratio: i=Z_{b}Zₑ/Z_{d}Zₐ=102×63/21×18=17<21
Within the allowable range

### 2) Z_{b}/Z_{d}=102/18=5.666666<8.

Within the allowable range
   3) 18/3, 21/3, 102/3, 63/3=integer teeth
Consistent with assembly condition

3. Verification of linear speeds of cam and push rod:
(1) P=Pb−Pc=0. The radial force of the cam is small. Cam: R_{b}=16 mm, h=10.5 mm.
   Average diameter, D=2R_{b}+h=16×2+10.5=42.8
      Let: nₕ=7000 r/min
      Then:
         v=D·π·nₕ/1000×60=42.5×π×7000/1000×60=15.577 m/s
      As indicated by the check result: the designed cam is a low-speed light-load running cam, which is consistent with the cam working condition.
(2) Check of linear speed of push rod:
   Push rod=2π stroke, L=18 mm, nₕ=7000r/min.
So: v=L nₕ/1000×60=18×7000/1000×60=2.1 m/s
The linear speed of the push rod is within the light-load low-speed range, and the design is reasonable.

### VI. Conclusions:

1. Safety and Reliability

As illustrated by the calculation and proof above, the “Gear/Cam Continuously Variable Transmission” is safe and reliable based on the mathematics or structural principles.

Through use of “meshed coupler”, load stepless speed change mechanisms and planetary gear mechanisms can be set into six groups. For example, the safety and reliability of a helicopter transmission are more outstanding. If one or two groups of load stepless speed change mechanisms and planetary gear mechanisms in the transmission are worn out or damaged, e.g., by bullets, the “Gear/Cam Continuously Variable Transmission” can continue working under load.

2. Fuel Efficiency and Environmental Protection

In over 90% of the running time, automobiles are driven between gear 3 to gear 5. It can be known from the calculation above that the mesh type transmission efficiency of gear 3 is 95.6%, the mesh type transmission efficiency of gear 4 is 97%, and the mesh efficiency of gear 5 is 97.2%. Fuel saving is reliable in load stepless speed change in comparison to the existing automobile transmission which saves fuel by about 30%.

Calculation is carried out by using percentage intermediate values of the abovementioned petroleum economization proportions: the intermediate proportions of petroleum economization of “Gear/Cam Continuously Variable Transmission” automobile in comparison to the existing continuously variable automobile are calculated as follows (see Background of the Invention above):

1) Petroleum economization in item 1: (10%+15%)/2=12.25%

2) Petroleum economization in item 2: (100−12.25)[(5+15)/2]%=8.775%

3) Petroleum economization in item 3: (100−12.25−8.775)[(10+15)/2]%=9.7%

4) Items 1+2+3=12.25%+8.775%+9.7%=30.725%

Therefore, “Gear/Cam Continuously Variable Transmission” automobile saves 30.725% petroleum than the existing continuously variable automobile; thus it would also reduce emission pollutants and waste gas by about 30.725%. For similar reasons, emission reduction for about 30% is also reliable.

Particularly in environmental protection: in case of running out of petroleum, since the damage degree of “biofuel” to the environment is 3-5 times higher than that of petroleum, the environmental protection advantage of the “Gear/Cam Continuously Variable Transmission” becomes even more significant.

3. Economy

The “Gear/Cam Continuously Variable Transmissions” of the present invention have numerous advantages over the existing technologies, for example, they are easy and reliable for controlling the stepless speed change mechanism and convenient for intelligent speed adjustment with very low costs; and meanwhile, the types of their parts are less than those in the existing automobile transmissions, thus convenient for batch production, and their manufacturing costs and applied resources are equivalent to those of the existing automobile transmissions. However, the excellent performance of the “Gear/Cam Continuously Variable Transmissions” highlights its superior economy.

4. Conclusions:

The “Gear/Cam Continuously Variable Transmissions” of the present invention could contribute to saving about 30% of energy and reducing about 30% of emission, and thus benefit the mankind greatly.

The foregoing examples and description of the preferred embodiments should be taken as illustrating, rather than as limiting, the present invention as defined by the claims. As will be readily appreciated, numerous variations and combinations of the features set forth above can be utilized without departing from the present invention as set forth in the claims. Such variations are not regarded as a departure from the spirit and script of the invention, and all such variations are intended to be included within the scope of the disclosure.

1. A stepless transmission, comprising:
a power input axle;
a power output axle;
a planetary gear mechanism; and
a speed changing assembly deposited on said power input axle through one or more gears;
wherein said power input axle and said power output axle are functionally connected by said planetary gear mechanism, and
wherein the transmission is capable of stepless speed change.

2. The stepless transmission of claim 1, wherein said planetary gear mechanism comprises a first planetary gear system and a second planetary gear system that are coupled with each other; wherein said first planetary gear system is connected to said power input axle, and said second planetary gear system is deposited on said power output axle; and wherein power is transmitted from said power input axle through said planetary gear mechanism to said power output axle.

3. The stepless transmission of claim 1, wherein said speed changing assembly comprises an axle, a cam, a gear rack piece, a ramp mechanism, one or more push rods, a mandrel, one or more gears, one or more springs, and an overrunning clutch system; wherein said cam is deposited on the power input axle; wherein said push rod, mandrel, and cam are kept connected through said springs, and said speed changing assembly can rotate around the power input axle; and wherein said ramp mechanism works together with the cam, the gear rack piece, the push rod, the mandrel, the springs, the one or more gears, and the overrunning clutch to achieve stepless speed change.

4. The stepless transmission of claim 3, wherein the cam pushes a push rod, and the push rod has four degrees of freedom to move radially up and down and/or move axially left and right.

5. The stepless transmission of claim 3, wherein the mandrel is characterized that while transmitting power, a pair of gears cause a power-transmitting gear to make additional power transmission through the mandrel.

6. The stepless transmission of claim 3, wherein power is input through said power input axle into a first member of the first planetary gear system via said cam, one or more gears, and members of said speed changing assembly; the power input is shunt into a second member of the first planetary gear system; and after being synthesized and transmitted by the first planetary gear system, the power is output through the power output axle through the second planetary gear system.

7. The stepless transmission of claim 4, wherein said gear rack piece moves to change the bevel angle of the ramp mechanism, thus causing continuously variable speed change.

8. The stepless transmission of claim 7, wherein said first gear planetary gear system and said second planetary gear system are each independently an NGW, NW, or WW planetary gear system.

9. The stepless transmission of claim 7, wherein the cam pushes the push rod while moving up and down in the radial direction and moving left and right around the power input axle, and in the meantime the push rod moves axially left and right and pushes a power transmission gear for additional power rotation (i.e., the additional power transmission), wherein said power transmission gear is engaged with a second power transmission gear to cause other gears to change speed to input power into the first planetary gear mechanism via said overrunning clutch; and wherein after being synthesized and transmitted by the planetary gear mechanism, the driving gear member achieves power output through the axle (III) of the second planetary gear mechanism (A).

10. A vehicle comprising a stepless transmission of claim 1.

11. The vehicle of claim 10, selected from automobiles, aircrafts, helicopters, tanks, warships, submarines, tractors, and mine and construction vehicles.

12. (canceled)

13. A stepless transmission, comprising a power input axle, a power output axle, one or more planetary gear mechanisms, and a speed changing means comprising a cam and a ramp mechanism, wherein the transmission is capable of stepless speed change.

14. The stepless transmission of claim 13, wherein the speed changing means further comprises one or more push rods, a mandrel, a clutch, a gear rack piece, one or more gears, and one or more springs, wherein one or more push rods and mandrel are kept connected with each other through said one or more springs, and one of said one or more push rods.

15. The stepless transmission of claim 14, wherein said clutch is an overrunning clutch.

16. The stepless transmission of claim 14, wherein the cam pushes one of the push rods, and said one of the push rods has four degrees of freedom to move radially up and down and/or move axially left and right.

17. The stepless transmission of claim 14, wherein the mandrel is characterized that while transmitting power, a pair of gears causes a power-transmitting gear to make additional power transmission through the mandrel.

18. The stepless transmission of claim 13, wherein power is input through the power input axle (I) into a first member (H) of a first planetary gear mechanism (B) via cam 10, gear 11, and other members of said speed changing means (7, 5, 4, 3, 2, 1, and 13); the power input is shunt into a second member of the first planetary gear mechanism (B); and after being synthesized by the first planetary gear mechanism (B), the power is output through a shaft member (III) of a second planetary gear mechanism (A).

19. The stepless transmission of claim 14, wherein the gear rack piece (9) moves to change the bevel angle of the ramp mechanism (8), and the cam (10) pushes a first push rod (7) while moving up and down in the radial direction and moving left and right around the shaft, and at the same time a second push rod (5) moves axially left and right and pushes a power transmission gear (3) for additional power rotation (i.e., the additional power transmission), wherein the power transmission gear (3) is engaged with another gear (11) to cause other gears (1 and 13) to change speed to input power into the first planetary gear mechanism (B) via an overrunning clutch (2); and after being synthesized and transmitted by the planetary gear mechanism (B), the driving gear member achieves power output through the shaft member (III) of the second planetary gear mechanism (A).

20. The stepless transmission of claim 13, as substantially shown in FIG. 4, comprising planetary gear mechanism 17, gears 15 and 16, cam 10, and pieces 1, 2, 3, 4, 5, 6, 7, 8, 9, 11, 12, 13, and 14, wherein pieces 1, 2, 3, 4, 5, 6, 7, 8, 9, 10, 11, 12, 13, and 14 are loading stepless speed change mechanisms which are classified into four groups and uniformly distributed around the power input axle (I) as circle center and taking the axle center distance of axle II from axle I as radius.

21. The stepless transmission of claim 20, wherein the interval among different groups is about 90°.

22. The stepless transmission of claim 20, wherein the turn angle in the working travel of cam piece (10) is about 210°; three groups of loading speed change mechanisms drive gear piece (16) at the same time at most; at least two groups drive gear piece 16 at the same time; and the four groups drive alternatively.

23. The stepless transmission of claim 20, wherein the clutch piece (2) is characterized in that: when the rotating speed of gear piece 1 is higher than that of gear piece 4, the overrunning clutch piece (2) slides without transmitting power; and when the rotating speed of gear piece (1) is lower than that of gear piece (4), gear piece 4 is meshed via overrunning clutch piece 2 to transmit power to gear piece 1 and gear piece 16 for serving as power output of planetary gear n_{b} member.

24. The stepless transmission of claim 20, wherein when cam piece 10 returns, gear piece 4 does not perform any additional rotating movement; and when its speed is lower than gear piece 1, the overrunning clutch slides, thus cam piece 10 returns without outputting power.

25. The stepless transmission of claim 20, wherein the push rod piece 5 is an inner-outer spiral involute spline sleeve, and its axial force P=0 is balanced to reduce radial force of cam and push rod; the spring piece 3 is designed to drive the push rod piece 5 and mandrel piece 14 to be always contacted with push rod piece 13; and the play or gap is not allowed so as to realize parking stepless speed change.

26. The stepless transmission of claim 20, wherein the spring piece 7 is designed to be taken as force sealing mechanism of cam piece 10 and push rods 11, 12 and 13, thus cam piece 10 and push rods 11, 12 and 13 are always in working state.

27. The stepless transmission of claim 20, wherein one face of the gear rack piece 9 is provided with a rack which is meshed with the gear of ramp piece 8, and the other face is provided with end face screw thread; four claws are designed for three-claw chuck via chisel; the centering performance of three-claw chuck has a centration error of about 0.025 mm; angles α of four slope pieces 8 can be adjusted by rotating disk in three-claw chuck via angle gear, thus loading stepless speed change is realized; and meanwhile, gear piece 9 is provided with “gap clearing” device specific to slope piece 8 and screw threads on disk end faces of three claws, thus making loading stepless speed change accurate.

28. A vehicle comprising a stepless transmission of claim 13.

29. The vehicle of claim 28, selected from automobiles, aircrafts, helicopters, tanks, warships, submarines, tractors, and mine and construction vehicles.

30-32. (canceled)
